(19) United States
(12) Patent Application Publication
(10) Pub. No.: US 2024/0399722 A1
(43) Pub. Date: Dec. 5, 2024

(54) Wrapping Material and Methods of Making Same

(71) Applicant: Tama Group, Kibbutz Mishmar HaEmek (IL)

(72) Inventors: Jeffrey Scott Wigdahl, Ames, IA (US); Tsafrir Lior, Kibbutz Mishmar HaEmek (IL); Yori Costa, Kibbutz Mishmar HaEmek (IL)

(73) Assignee: Tama Group, Kibbutz Mishmar HaEmek (IL)

(21) Appl. No.: 18/697,177

(22) PCT Filed: Sep. 30, 2022
(86) PCT No.: PCT/US2022/045403

§ 371 Date: Mar. 29, 2024

Related U.S. Application Data
(60) Provisional application No. 63/251,283, filed on Oct. 1, 2021.

(51) Int. Cl. B32B 27/08; A01F 15/07; B32B 3/30; B32B 27/36; B32B 37/18

(52) U.S. Cl. CPC B32B 27/08; B32B 3/30; B32B 27/36; B32B 37/182; A01F 15/0715; A01F 2015/0745; B32B 2307/7265; B32B 2410/00

(57) ABSTRACT

In one embodiment of the present disclosure, a wrapping material for wrapping around an agricultural product to form a bale includes a wrapping unit extending from a leading end to a trailing end. The wrapping unit includes a reduced risk material portion extending a distance along the wrapping unit from the leading end.

### CROSS-REFERENCE TO RELATED APPLICATION

The present application claims the benefit of the filing date of U.S. Provisional Application No. 63/251,283, filed Oct. 1, 2021, entitled Wrapping Material and Methods of Making Same, the disclosure of which is hereby incorporated herein by reference.

### BACKGROUND OF THE INVENTION

The U.S. cotton industry has long been using automated machinery to harvest, bale and wrap cotton. The wrapping is performed using long polymeric sheets which wrap around the perimeter of a cylindrical-shaped bale of harvested cotton. The polymeric sheet is sealed to secure the bales of cotton. The polymeric sheet offers not only securement of the harvested cotton, but can also protect the wrapped cotton from weather, including UV radiation and precipitation.

However, one drawback to these current polymeric-based products is that they, of course, contain a larger amount of plastics. While these polymeric sheets, and related automated process, revolutionized the cotton market, this technology also brought the drawback of the risk of quality degradation of the harvested cotton due to potential plastic contamination. While plastic contamination can come from other sources, a not insignificant percentage is caused by these polymeric sheets. For example, when the baled and wrapped cotton is sent for processing, e.g., to a cotton gin, the first step is to open the wrap and release the baled cotton. Typically, to release the wrap, the wrap is cut. A common issue that occurs during cutting of the wrap is that loose parts of the wrap can comingle with the cotton, potentially entering the cotton stream. This plastic contamination in the cotton stream could eventually end up in the ginned cotton which is then sent for further processing, such as to a spinning mill. Although any portion of the wrap is capable of contaminating cotton, the typical source for these loose plastic pieces is from the inner layer of wrap that contacts the cotton (a typical wrap wraps around a cotton bale about three times), and specifically, the leading end portion of the wrap is considered to be the most vulnerable and the largest contributor to cotton contamination.

Therefore, while the current wraps overall are a beneficial and useful tool in the cotton baling and wrapping process, an improved wrap that addresses at least the above-noted shortcomings surrounding cotton contamination is desirable. Further, of course, eliminating plastic use where possible can also have other environmental benefits.

### BRIEF SUMMARY OF THE INVENTION

In one aspect, a wrapping material for wrapping around a baled agricultural product, the wrapping material includes a wrapping unit extending from a leading end to a trailing end, the wrapping unit including a reduced risk material portion extending a distance along the wrapping unit from the leading end.

Continuing with this wrapping material, wherein the reduced risk material portion has a length that extends around at least a portion of a perimeter of the baled agricultural product when the wrapping material is wrapped around the baled agricultural product.

Continuing with this wrapping material, wherein the wrapping unit further includes a polymeric portion extending a distance along the wrapping unit from the trailing end.

Continuing with this wrapping material, wherein the polymeric portion has a length that extends around at least a portion of the perimeter of the baled agricultural product, wherein the wrapping unit completes at least one revolution around the baled agricultural product.

Continuing with this wrapping material, wherein the wrapping unit has a length that extends at least two revolutions around the baled agricultural product.

Continuing with this wrapping material, wherein the reduced risk material portion has a length sufficient to extend at least one complete revolution around the baled agricultural product, and the polymeric portion has a length sufficient to extend around at least a portion of the perimeter of the baled agricultural product.

Continuing with this wrapping material, wherein the reduced risk material portion is adjacent to the baled agricultural product and the polymeric portion is positioned over at least part of the reduced risk material portion.

Continuing with this wrapping material, wherein the reduced risk material portion has a length that extends at least one complete revolution around the perimeter of the baled agricultural product when the wrapping material is wrapped around the baled agricultural product.

Continuing with this wrapping material, wherein the polymeric portion has a length that extends around the baled agricultural product at least in a second layer to cover at least part of the reduced risk material portion when the wrapping material is wrapped around the baled agricultural product.

Continuing with this wrapping material, wherein the reduced risk material portion has a length that extends more than one complete revolution around the perimeter of the baled agricultural product such that a second layer of the reduced risk material portion covers at least part of a first layer of the reduced risk material portion when the wrapping material is wrapped around the baled agricultural product.

Continuing with this wrapping material, wherein the reduced risk material portion extends from the leading end to the trailing end of the wrapping unit.

Continuing with this wrapping material, wherein the reduced risk material portion includes a water-resistant additive, treatment or coating.

Continuing with this wrapping material, wherein a plurality of wrapping units are releasably attached in a sequence, such that the trailing end of each wrapping unit is releasably attached to the reduced risk material portion of a trailing wrapping unit.

Continuing with this wrapping material, wherein the reduced risk material portion of the wrapping unit is a predetermined length and width.

Continuing with this wrapping material, wherein the reduced risk material portion is formed of crepe paper defining ridges configured to allow the crepe paper to expand and contract.

Continuing with this wrapping material, wherein the polymeric portion extends between the paper portion and the trailing end.

Continuing with this wrapping material, wherein the reduced risk material portion of the wrapping unit extends from the leading end to the trailing end, and the wrapping unit is configured to be cut into individual wrapping unit portions for each portion sized to be wrapped around the baled agricultural product.

Continuing with this wrapping material, wherein the wrapping unit further includes a polymeric portion extending a distance along the wrapping unit from the trailing end, the reduced risk material portion sized to be included in a first portion of a first layer of the wrapping unit, and the polymer portion sized to be included in a second portion of the first layer of the wrapping unit, a second layer of the wrapping unit, and a third layer of the wrapping unit, wherein the polymer portion in the second portion of the first layer is adhered to the second layer and the second layer is adhered to the third layer.

In another aspect, a method of wrapping, including applying a leading end of a wrapping unit to a perimeter of an object to be wrapped, the wrapping unit having a length between the leading end and a trailing end and including a reduced risk material portion extending from the leading end towards the trailing end; applying the reduced risk material portion along at least a portion of the perimeter of the object; and applying a polymeric portion of the wrapping unit along at least a portion of the perimeter of the object such that the reduced risk material portion and the polymeric portion together extend at least one complete revolution around the object, wherein the polymeric portion extends from the end of the reduced risk material portion to the trailing end of the wrapping unit.

Continuing with this method, wherein applying the reduced risk material portion includes wrapping the reduced risk material portion at least one complete revolution around the object.

Continuing with this method, wherein the step of applying the polymeric portion of the wrapping unit includes applying the polymeric portion along at least a portion of the reduced risk material portion.

Continuing with this method, wherein applying the polymeric portion includes wrapping the polymeric portion around at least part of the reduced risk material portion such that the polymeric portion covers the reduced risk material portion.

Continuing with this method, wherein applying the polymeric portion includes wrapping a second layer of the polymeric portion around at least part of the first layer of the polymeric portion.

Continuing with this method, wherein applying the polymeric portion includes wrapping a second layer of the polymeric portion around at least part of a first layer of the polymeric portion such that the second layer of the polymeric portion covers the reduced risk material portion and the first layer of the polymeric portion.

Continuing with this method, wherein applying the reduced risk material portion includes wrapping at least a second layer of the reduced risk material portion around at least part of the first layer of the reduced risk material portion.

Continuing with this method, wherein the wrapping unit is one of a plurality of wrapping units coupled sequentially to one another such that a trailing end of a first wrapping unit is releasably attached to the leading end of a second wrapping unit, the method further including, after applying the polymeric portion to the object, wrapping a perimeter of a second object using a second wrapping unit extending from a leading end to a trailing end, the second wrapping unit including a reduced risk material portion extending a distance along the second wrapping unit from the leading end, the second wrapping unit further including a polymeric portion extending a distance along the second wrapping unit from the trailing end; applying the leading end and the reduced risk material portion of the second wrapping unit to at least a portion of the perimeter of the second object; and applying the polymeric portion of the second wrapping unit to at least a portion of the perimeter of the second object.

In yet another aspect, a method of manufacturing a wrapping unit, including forming a reduced risk material portion having a length and a width; forming a polymeric portion having a length and a width; and securing the polymeric portion to the reduced risk material portion.

Continuing with this method, wherein forming a wrapping unit further comprises forming a plurality of wrapping units extending in a sequence, a trailing end of each leading wrapping unit releasably attached to a leading end of a trailing wrapping unit.

Continuing with this method, wherein the releasable attachment between the trailing end of each leading wrapping unit to the reduced risk material portion of a trailing wrapping unit includes a Z-Lock system, the Z-Lock system including a V-fold on one of the wrapping units.

Continuing with this method, wherein the securing step includes securing a leading end of the polymeric portion to a trailing end of the reduced risk material portion.

Continuing with this method, wherein the securing step includes securing the polymeric portion to the reduced risk material portion along the widths of both the polymeric and reduced risk material portions.

In another aspect, a method of wrapping an agricultural product includes traversing a field with a work machine; collecting the agricultural product from the field with the work machine; forming the collected agricultural product into a bale in a chamber of the work machine, wherein the bale has a shape extending along a central axis; applying a reduced risk wrapping material to a longitudinal exterior surface of the bale in the chamber of the work machine; applying a polymeric wrapping material to the longitudinal exterior surface of the bale in the chamber of the work machine; and ejecting the bale from the chamber of the work machine.

Continuing with this method, wherein the polymeric wrapping material is applied to the bale after the reduced risk wrapping material is applied to the bale.

Continuing with this method, wherein (i) the work vehicle is a cotton harvester and (ii) the agricultural product is seed cotton.

Continuing with this method, wherein applying the reduced risk wrapping material to the bale includes wrapping the entire longitudinal exterior surface of the bale in the reduced risk wrapping material.

Continuing with this method, wherein applying the reduced risk wrapping material to the bale includes wrapping less than the entire longitudinal exterior surface of the bale in reduced risk wrapping material.

Continuing with this method, wherein applying the polymeric wrapping material to the bale includes wrapping the entire longitudinal exterior surface of the bale in the polymeric wrapping material.

Continuing with this method, wherein the reduced risk wrapping material includes paper.

Continuing with this method, wherein the reduced risk wrapping material is connected to the polymeric wrapping material prior to being applied to the bale.

Continuing with this method, wherein the reduced risk wrapping material is a first section of a respective wrap portion of a supply roll of wrap material and the polymeric wrapping material is a second section of the respective wrap portion of the supply roll of wrap material.

Continuing with this method, further comprising attaching an inner-surface of the second section of the respective wrap portion to an outer-surface of the first section of the respective wrap portion prior to ejecting the bale from the chamber of the work machine.

Continuing with this method, wherein the first section of the respective wrap portion includes a coating applied to at least one surface of the reduced risk wrapping material.

In yet another aspect, a method of wrapping an agricultural product, including traversing a field with a work machine; collecting the agricultural product from the field with the work machine; forming the collected agricultural product into a bale in a chamber of the work machine, wherein the bale has a shape extending along a central axis; applying paper wrap to a longitudinal exterior surface of the bale in the chamber of the work machine; applying a polymeric wrap to the longitudinal exterior surface of the bale in the chamber of the work machine; and ejecting the bale from the chamber of the work machine.

Continuing with this method, wherein the polymeric wrap is applied to the bale after the paper wrap is applied to the bale.

Continuing with this method, wherein (i) the work vehicle is a cotton harvester and (ii) the agricultural product is seed cotton.

Continuing with this method, wherein applying the paper wrap to the bale includes wrapping the entire longitudinal exterior surface of the bale in the paper wrap.

Continuing with this method, wherein applying the paper wrap to the bale includes wrapping less than the entire longitudinal exterior surface of the bale in paper wrap.

Continuing with this method, wherein applying the polymeric wrap to the bale includes wrapping the entire longitudinal exterior surface of the bale in the polymeric wrap.

Continuing with this method, wherein the paper wrap is connected to the polymeric wrapping material prior to being applied to the bale.

Continuing with this method, wherein the paper wrap is a first section of a respective wrap portion of a supply roll of wrap material and the polymeric wrap is a second section of the respective wrap portion of the supply roll of wrap material.

Continuing with this method, further comprising attaching an inner-surface of the second section of the respective wrap portion to an outer-surface of the first section of the respective wrap portion prior to ejecting the bale from the chamber of the work machine.

Continuing with this method, wherein the first section of the respective wrap portion includes a coating disposed on a surface of the paper wrap.

Continuing with this method, wherein the paper wrap includes one or more polymeric elements.

In another aspect, a method of removing a wrapping material from a wrapped baled item, the method including: obtaining the wrapped baled item, wherein the baled item is wrapped by a wrapping material including a first portion formed of a first material and a second portion formed of a synthetic polymer; cutting the wrapping material at any location on the wrapping material to release the wrapping material from the baled item; and removing the wrapping material from the baled item, wherein the second portion of the wrapping material can be removed from the baled item in a single piece regardless of the location the wrapping material was cut. Further, the first material may be a reduced risk material. Still further, the reduced risk material may be an innocuous material, such as paper or a paper-like material. Moreover, the synthetic polymer may be plastic, for example, a polyethylene. Further, yet, the second portion may extend at least two revolutions around the baled item such that the entire length of the second portion is in contact with itself within the at least two revolutions. Still further, the second portion may include at least one tacky surface along at least a portion of its length, wherein the part of the second portion in each of the at least two revolutions adheres to at least one adjacent revolution.

In a further aspect, a method of producing processed cotton raw material having no or substantially no plastic contamination originating from a wrapping material, the method including: obtaining a wrapped cotton bale, the cotton bale is wrapped by the wrapping material including a first material forming a leading portion and a second material forming a trailing portion, the first material different from the second material; cutting the wrapping material at any location on the wrapping material to release the wrapping material from the baled item; removing the wrapping material from the baled item, wherein during removal a portion of the first material remains with the cotton bale; and separating the portion of the first material remaining with the cotton bale from the cotton bale manually by hand or mechanically by cotton processing equipment such that no or substantially no plastic is present in the processed cotton. The first material can be a reduced risk material, such as paper or stiffened plastic. The second material can be plastic, wherein following the cutting step, no portion of the second material remains with the cotton bale. The cotton processing equipment can be cotton gin equipment, cotton cleaning equipment or cotton spinning equipment.

### BRIEF DESCRIPTION OF THE DRAWINGS

FIG. 1A is a schematic top view of a flattened wrapping unit according to an embodiment of the disclosure.

FIG. 1B is a schematic top view of a flattened wrapping unit according to another embodiment of the disclosure.

FIG. 1C is a schematic top view of a flattened wrapping unit according to yet another embodiment of the disclosure.

FIG. 1D is a schematic top view of a flattened wrapping unit according to a further embodiment of the disclosure.

FIG. 2A is schematic side view of the wrapping unit of FIG. 1A wrapped around a bale of cotton.

FIG. 2B is a schematic side view of the wrapping unit of FIG. 1B wrapped around a bale of cotton.

FIG. 2C is a schematic side view of the wrapping unit of FIG. 1C wrapped around a bale of cotton.

FIGS. 3A-B are enlarged schematic views of one variation of a releasable connection between two wrapping units.

FIG. 3C is an enlarged schematic view of another variation of a releasable connection between two wrapping units, largely similar to that illustrated in FIGS. 3A-B.

FIG. 4 is a schematic side view of a harvester according to an embodiment of the prior art.

FIG. 5 is a schematic view of the baling chamber inside the harvester of FIG. 4.

FIGS. 6, 7A, and 7B are schematic views of the baling chamber and certain elements which may manipulate a wrapping material according to another embodiment of the prior art.

### DETAILED DESCRIPTION

The present disclosure describes various apparatus and methods for a wrapping material which may be wrapped around an object. The wrapping material as described herein will be discussed in the context of wrapping bales of cotton. However, it should be noted that the wrapping material may be used to wrap any object or group of objects including, but not limited to, any agricultural products, such as wheat, paper, silage, hay, or the like, as well as non-agricultural products such as garbage or waste. As used herein, the terms “generally,” “substantially,” “approximately,” and “about” are intended to mean that slight deviations from absolute are included within the scope of the term so modified.

In one aspect of the present disclosure, a wrapping unit for use in wrapping an agricultural bale may be formed of, at least in part, a material that can reduce the risk of detrimentally contaminating the agricultural product being wrapped, resulting in a product that is of higher quality because it is free or substantially free of detrimental contaminants. As mentioned above, if plastic particles or pieces end up in the agricultural product during processing, the product could end up being of low quality, or worse unusable. This is particularly true of cotton, which will be the exemplary agricultural product discussed throughout this disclosure, in that plastic particles remaining in processed cotton can severely degrade the quality of the cotton. This is particularly important in markets generally known as having reliable, high-quality cotton product, such as the U.S. cotton industry. For example, in instances where the cotton is dyed, such as dyed yarn for a t-shirt, a particle of plastic remaining in the cotton cannot accept the dye and thus remains as a dot of a different color from the rest of the yam.

Thus, such materials that can reduce the risk of detrimentally contaminating the agricultural product being wrapped, if included as part of the wrapping unit in place of the typical plastic, can reduce the risks of plastic contamination because either (1) the material can be easily identified and removed from the agricultural product stream, or (2) even if the material remains in the product as a contaminant, it should be an inert or non-harmful contaminant. Such materials will be generally referred to herein as “reduced risk materials.”

Examples of reduced risk materials are discussed throughout the present disclosure, and can be separated into two main groups: “innocuous materials” and “high strength polymeric materials.” Innocuous materials may be organic materials or synthetic materials formed using natural organic raw materials. Representative examples of an innocuous material are paper or paper-like materials, cellulose-based materials (e.g., cellulose-based nonwoven fabric, Rayon), starch-based materials, linen and other natural fiber materials (including cotton-based materials). Such innocuous materials are further capable of, if left in the cotton (for example) through processing of the cotton into a usable product, it will cause minimal if any harm to the usable product in that it should not harm the integrity of the product, it should be capable of accepting dye, or otherwise have little to no effect on the quality of the cotton or the resulting usable product. Also, such innocuous materials may be more easily removed using cotton cleaning equipment and/or cotton spinning equipment.

High strength polymeric materials may be plastic materials that, relative to traditional plastics used as wrapping material, has characteristics that are intended to reduce the risk of small pieces or particles of plastic from commingling with the agricultural product. For example, plastic films that are thicker than normal plastic films used for such wraps, or films that are reinforced to increase their strength, may be beneficial in that such films are more difficult to shred, break apart, or tear and may also be a heavier and/or stiffer material. As such, these materials, if they do tear away from the rest of the wrapping unit, would tear into larger pieces that are more easily identifiable and/or are easier for the processing equipment to remove during normal processing, and further, the heavier weight of the material may allow such pieces to fall away from the cotton easier.

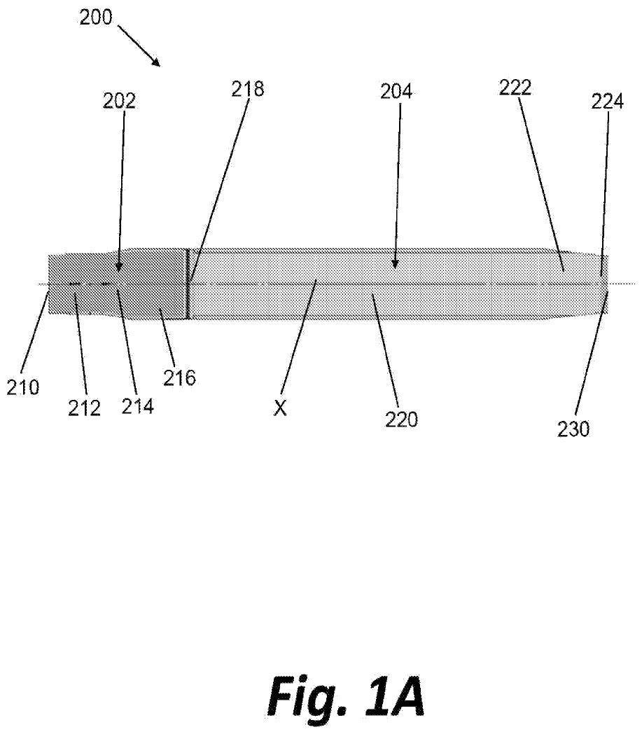

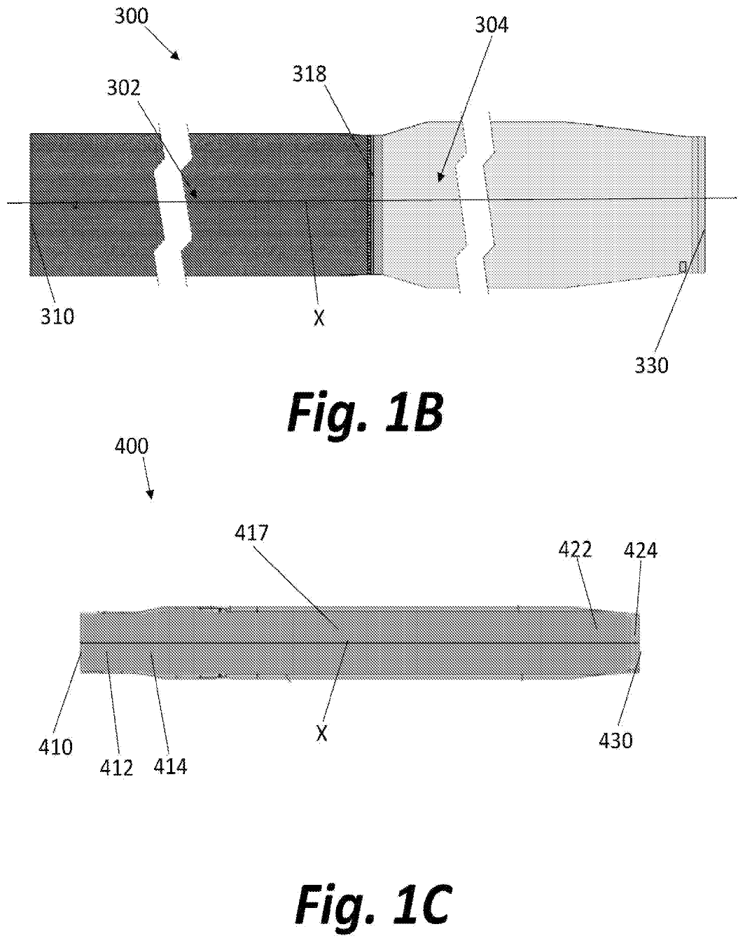

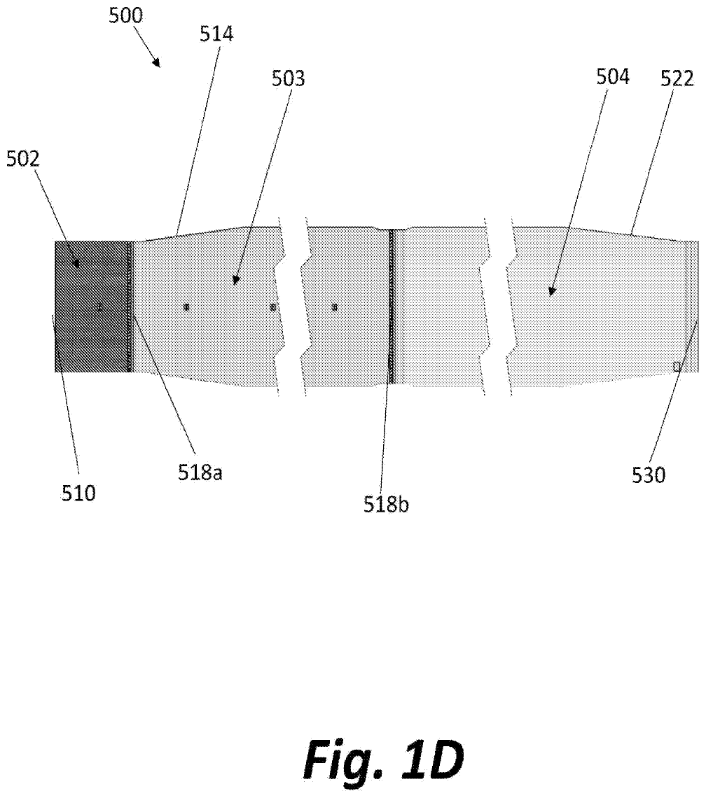

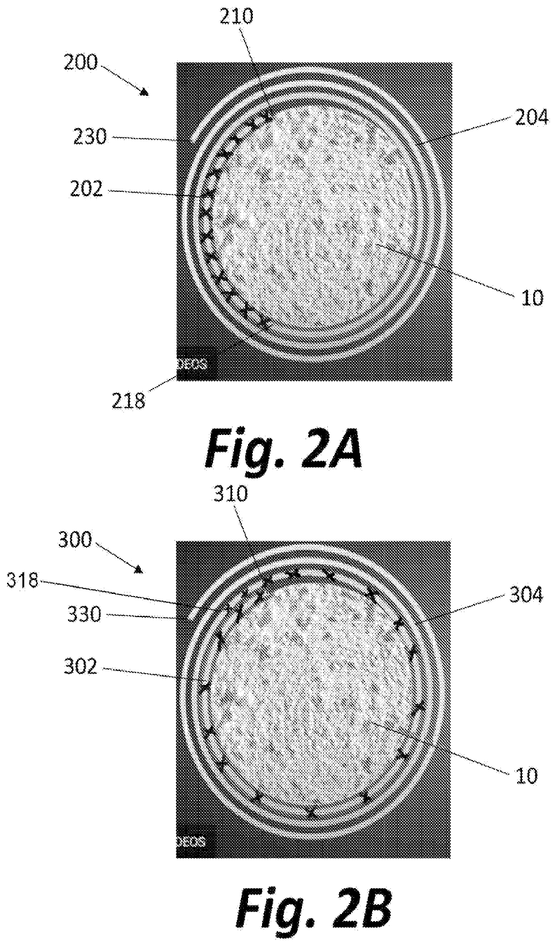

FIGS. 1A-1D illustrate various representative embodiments of wrapping units including such reduced risk materials in at least part of, all of, or substantially all of its construction. While these embodiments are generally discussed for their use as wrap for cotton, and as using an innocuous material, specifically paper, as the reduced risk material, variations of these wrapping units are also envisioned.

FIG. 1A illustrates an example of a wrapping unit 200 according to an embodiment of the disclosure. Wrapping unit 200 is shown in FIG. 1A in an elongated flattened view. Wrapping unit 200 extends from a leading edge 210 to a trailing edge 230 along longitudinal axis X. Wrapping unit 200 includes a leading side 202 adjacent to and including leading edge 210, a trailing side 204 adjacent to and including trailing edge 230, and, if present, a transition zone 218 positioned between leading side 202 and trailing side 204. Leading side 202 of wrapping unit 200 may include a leading portion 212 extending from and including leading edge 210. Leading portion 212 may have a first width, wherein the width is defined as the distance in which wrapping unit 200 extends in a direction perpendicular to longitudinal axis X. In some examples, the width of leading portion 212 may be substantially the same as the width of, for example, a bale of cotton around which the wrapping unit may be wrapped. In other examples, the width of leading portion 212 may be less than a width of a bale of cotton. Wrapping unit 200 may further include a leading tapering portion 214 adjacent leading portion 212 and extending from leading portion 212 toward trailing edge 230. Leading tapering portion 214 may have a tapering width, such that the width of wrapping unit 200 increases as leading tapering portion 214 extends from leading portion 212 toward trailing edge 230. Wrapping unit 200 may further include a leading intermediate portion 216 adjacent leading tapering portion 214 and extending from leading tapering portion 214 toward trailing edge 230. Leading intermediate portion 216 may have a consistent width that is greater than the width of leading portion 212. In some examples, leading intermediate portion 216 may have a width that is substantially equal to the width of a bale of cotton around which wrapping unit 200 is to be wrapped (wherein the width of leading portion 212 would be smaller than the width of the bale of cotton in such an example). In other examples, leading intermediate portion 216 may have a width greater than a bale of cotton, such that the width of leading intermediate portion 216 slightly overhangs the cotton bale, which may allow for the overhang to wrap over the edge of the bale which may provide further protection to the baled cotton, though in other embodiments intermediate portion 216, along with leading portion 212 and tapering portion 214, may all have widths less than the width of the baled cotton. Depending on the first material used for leading side 202, it may be preferable for the width of the entirety of leading side 202 to be about the same as or less than the width of the baled cotton since the selected first material may not be suitable for wrapping over the edge of the baled cotton.

Wrapping unit 200 may further include transition zone 218 at some location along the length of the unit 200. As shown in this embodiment of FIG. 1A, transition zone 218 is adjacent leading intermediate portion 216. Transition zone 218 may be a location or area on wrapping unit 200 in which the material of wrapping unit 200 changes from a first material to a second material. In other words, leading side 202 of wrapping unit 200 may include and/or be formed of a first material, and trailing side 204 of wrapping unit 200 may include and/or be formed of a second material different than the first material. Leading side 202 and trailing side 204 may be coupled at transition zone 218, for example, by applying an adhesive (such as glue), a tape, thermal energy (e.g., to cause a portion of at least one side to melt and adhere to the other side), or the like to hold the sides together. In some examples, leading side 202 may include a reduced risk material, such as paper, such that, if a piece of the reduced risk material is found in the seed cotton upon removal of the wrapping material, it can be easily removed via normal processes in the gin or other processing prior to fabrication. Using an innocuous material, such as paper, has the added benefit in that, if it is not removed from the cotton, the material would not create a defect. As noted above, using such reduced risk materials to form at least part of, or all of, leading side 202 can have particular benefits since the leading side 202 is generally considered to be the most likely source of cotton contamination by the wrapping material itself.

Trailing side 204 may include and/or be formed of various types of materials, such as synthetic polymers, namely plastics, such as polyolefins, for example polyethylene, such as linear low-density polyethylene (LLDPE), or the like. It should be understood that reference to “plastic” herein may be interchangeable with any of the similar named materials. Trailing side 204 may further include a tacky, semi-tacky or non-tacky film or coating covering the plastic, or any combination thereof along the length and/or width of trailing side 204, as described below in greater detail. For example, the polymeric material may be plastic film, including one or more layers of plastic film of the same or varying materials. For example, the plastic film in trailing side 204 may include one or more layers of LLDPE, such as is used in TamaWrap® (Tama Group, Israel, the applicant and assignee of the present application). Similar to TamaWrap®, the trailing side 204 may be substantially nontacky or may have a tacky surface along part, all, or substantially all of its length. The tacky surface may be along part, all, or substantially all of one surface of trailing side 204, or may be along part, all or substantially all of both surfaces (i.e., top and bottom surfaces of trailing side 204) along its length. Though, despite providing numerous benefits to the wrap as discussed herein, including such optional tacky surfaces on the wrapping material may result in a wrap that is more difficult to handle and/or manipulate through a harvesting and wrapping machine. This is particularly true where both sides of the wrapping material are tacky.

In other embodiments, the dimensions and location of the various features illustrated in FIG. 1A may differ as desired. For example, while wrapping unit 200 of FIG. 1A tapers (leading tapering portion 214) within the structure of leading side 202, the tapering, to the extent tapering exists at all, may alternatively (or additionally) occur within the structure of trailing side 204. In other words, the structure of such a wrapping unit may include a leading side of a generally constant width (or of varying width(s) as desired), and then the leading side transitions to a trailing side at a transition zone. Then, in between the transition zone and the trailing edge, the trailing side may include one or more tapers. Thus, in one particular example, a leading side may be formed of paper and have a substantially constant width along its length. The paper leading side is then secured to a trailing side, which may be formed of a plastic film as known in the art, such as LLDPE. The paper and plastic film may be secured to one another using an adhesive or tape at a transition zone. At some point along the length of the plastic film, the width of the plastic film may taper from a width about equal to the paper to a width wider than the paper. As noted above, the wider width of the plastic film may provide protection of the edge of the baled cotton by the film wrapping around the edge and along a portion of the side of the baled cotton. In other words, the paper portion of the wrapping unit may end before the width of the wrap begins increasing, and the portion of the wrap having an increased width relative to leading side 212 may be formed of plastic as shown, for example, in FIG. 1B. Of course, other variations to these dimensional characteristics are possible to adjust the amount of first material (e.g., paper) is in the wrapping unit versus amount of second material (e.g., plastic film), the width of any portion of the wrapping unit, the locations of any transition zone, taper(s), and the like. To provide yet another example of such a variation, the taper along the plastic trailing side may occur at the transition zone, such that, as soon as the wrapping unit transitions to the second material (e.g., plastic film), the width of the wrapping unit starts increasing from the initial width of the leading side and transition zone.

Paper (and other innocuous materials) as the reduced risk material may be less elastic than traditional plastic film, and thus may not stretch as much as a plastic. While such papers are quite strong, the limited elasticity results in a relatively rigid wrapped object. As such, paper with an increased elasticity as compared to normal paper materials can be used which can provide improved flexibility to allow for some expansion, which may reduce the risk of the paper simply tearing under stress. For this reason, extensible paper may be a good option for the innocuous material as it has greater elasticity than typical paper. For instance, a preferred elasticity may be around 8% (measured as the percentage increase in linear dimensions of a flat sheet of paper upon application of a stretching force, measured in any direction in the x-y directions on the flat sheet), which provides a beneficial balance of strength and rigidity relative to elasticity. Further, for example, such a paper with this elasticity specification may be combined with a tacky coating on at least a portion of the wrapping material, which may help adjacent wrapping layers around a bale adhere to one another (as discussed herein), to still further increase the overall strength of the wrap around a baled item. Examples of such materials are TEA-Kraft Rigid® paper and FiberShield® paper (both from WestRock, Longview, WA).

In some examples, the innocuous material, such as paper, may include an additive, coating, or other treatment to impart greater durability, including increased water resistance, resistance to weather, particularly humidity and precipitation, and from moisture in the object being wrapped. Such coating may be applied to one or both sides of the paper. For example, the inclusion of paraffin film, thin polyethylene layer, or a wax may improve the water resistance of the paper while still preserving the biodegradability of the paper and mitigating risk of contamination. A coating, film, treatment, etc., may also provide a barrier or shield from the surrounding humidity of the environment in which the paper/bale is stored and/or used to reduce or eliminate weakening of the paper. Some embodiments may include B-Wrap® coatings, SCM®, or other web or film materials made and/or used by Tama Group (formerly Tama Plastic Industry, Israel) for the baling and/or protection of agricultural products, such as from at least sun, rain, snow, and/or ground moisture, certain of which are further described in U.S. Pat. Nos. 7,636,987 and 7,625,332, the disclosures of which are incorporated by reference herein. In still further embodiments, at least a portion of the paper may include a super-hydrophobic coating to further protect the paper from moisture, including, but not limited to, hydrophobic silica, advanced plasma coating and other coatings that may inhibit or prevent water from remaining on the paper degrading its properties. Such coatings, films or treatments may be on at least part of at least one surface of the wrapping material, and similarly, additive(s) may be integrated into at least part of the volume of the wrapping material.

Instead of a coating, in some examples, the paper (or other innocuous material) may be generally water resistant by an additive or treatment impregnating the paper volume with such materials discussed above. In such examples, the treatment is not simply a coating but instead is an additive present throughout the entire volume of the paper which may protect and maintain the integrity of the paper. As noted above, examples of such paper include TEA-Kraft Rigid® paper and FiberShield® paper.

In some examples, the innocuous material may be crepe paper, having a crimpled, folded or crinkled texture, the crinkles configured to unfold or straighten out when the crepe paper is placed under tension. The expandable properties of the crepe paper create strong, flexible material with high elongation. Such qualities allow the paper to safely stretch and expand when tension is applied to the paper and retract when the paper is compressed or released from an expanded state allowing the paper to return to a crinkled resting state. Crepe paper may be stretched during the wrapping cycle, as it is wrapped around an object, such as cotton, ensuring a tight compression over the cotton to secure the bale together while in transit from the point of wrapping to the point of unwrapping. Alternatively, the crepe paper may maintain at least some of the crimps and folds throughout the wrapping cycle, allowing some limited expansion of the cotton following wrapping. Providing such an allowance for limited expansion may further serve to maintain the integrity of the wrapped bale in instances where the original wrapping was too tight, given the limited stretchability of paper in general. It should be understood that any combination of the examples described above may be used and/or applied to the paper in any embodiment of the disclosure.

Moreover, certain innocuous materials may have a smooth surface (except for crepe paper, for instance) which may be preferred for various reasons, but could allow for a risk of failed feeding into a machine, where the machine feeding elements (e.g., rollers) may have an issue in gripping the smooth surface. As such, an optional surface texture may be formed on at least a portion of at least one surface of the paper to provide a surface that the machine can grip more reliably. Such a surface texture may be a roughened surface, a tacky or mild adhesive surface, or the like.

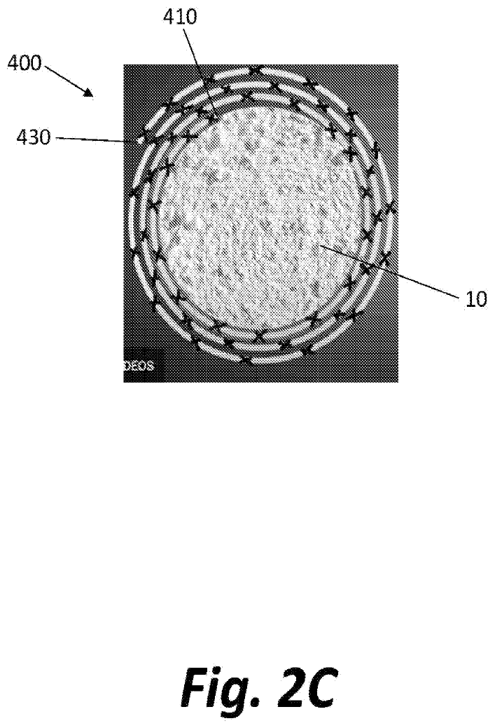

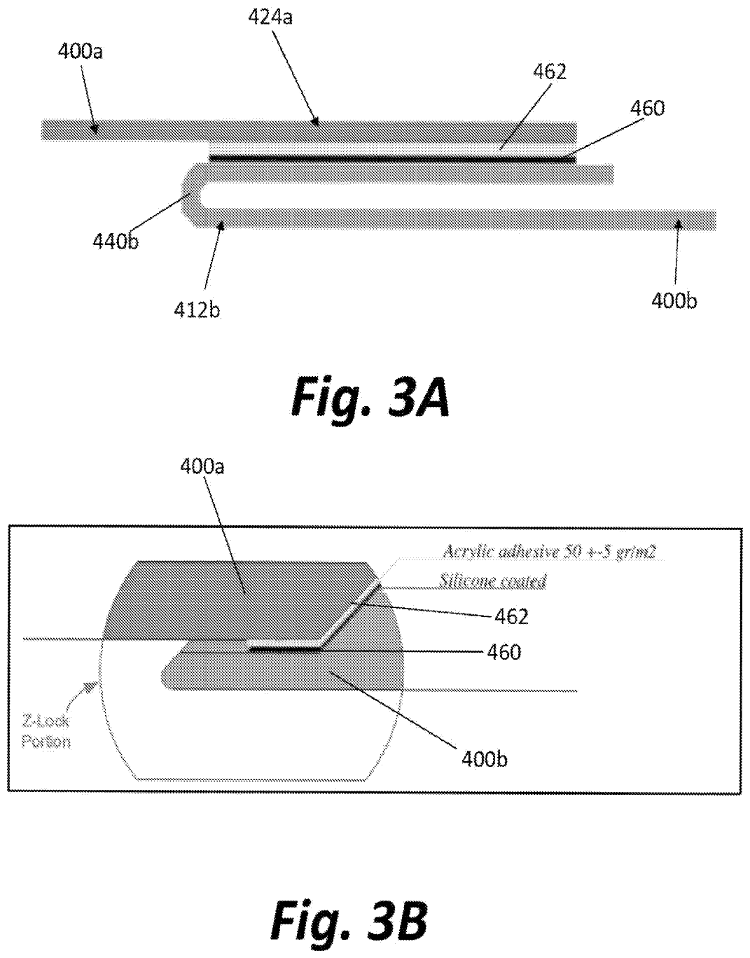

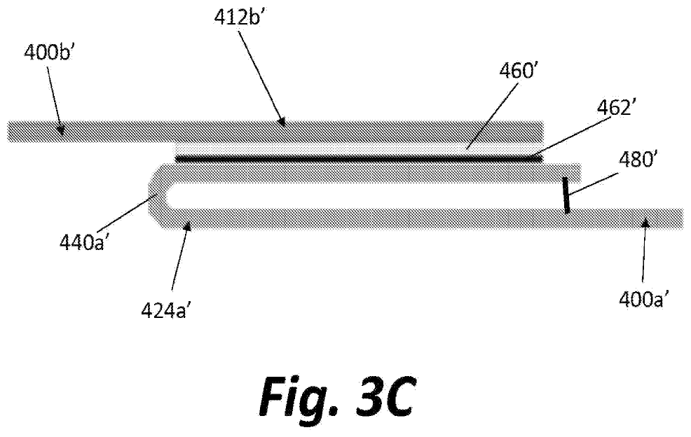

Additionally or alternatively, one or more layers of trailing side 204 may be of a material capable of melting upon exposure to an energy source, such as ethylene vinyl acetate copolymer resin (EVA), ethylene butyl acrylate (EBA), PE or polyamide (PA, or Nylon), or combinations thereof. In a particular example, such a layer may include 80-99.5% EVA, with 19% vinyl acetate by weight (EVA19), with the balance being carbon black. In another arrangement, EVA may be more than 90% of the layer, with the balance being carbon black. In another example, this melt layer may also be substantially entirely comprising LLDPE, along with the presence of an additive that can absorb energy and melt part of or the entire layer. In such an example, the film of trailing side 204 may be nontacky during application onto the object, but once it is in place on the object, application of energy can melt this polymer layer, causing it to become tacky, and even causing it to adhere to another layer of trailing side 204 against which it may be facing and abutting (such face-to-face layers are illustrated in FIGS. 2A-2B, for example, discussed below).

Continuing with the embodiment illustrated in FIG. 1A, trailing side 204 of wrapping unit 200 may include a trailing intermediate portion 220 adjacent transition zone 218 (if present) extending from transition zone 218 toward trailing edge 230. Trailing intermediate portion 220 may have a consistent width substantially equal to the width of leading intermediate portion 216, though as discussed above, trailing intermediate portion 220 may include at least one taper. As noted above, while the first material may not be suitable for having a width that allows for covering over the edge of a baled object, the second material of trailing side 204 may still have a width that can provide protection to the edge of the baled object, and inside the sides of the first material, similar to the width of the plastic layers in TamaWrap® which provides such protection to the edge of wrapped cotton bales.

Trailing side 204 may further include a tapering trailing portion 222 adjacent trailing intermediate portion 220 and extending from trailing intermediate portion 220 toward trailing edge 230. Tapering trailing portion 222 may have a width tapering inwardly (i.e., decreasing) as trailing tapering portion 222 extends from trailing intermediate portion 220 toward trailing edge 230. Trailing side 204 may further include trailing portion 224 adjacent trailing tapering portion 222 and extending between trailing tapering portion 222 and trailing edge 230. Trailing portion 204 may include a structure for coupling wrapping unit 200 to another wrapping unit and/or for ultimately sealing the wrapping unit 200 around an object, as discussed below in greater detail.

It is contemplated that wrapping units of the present disclosure may have any predetermined length and width, preferably enough to cover the circumference or perimeter of the item to be wrapped. For example, in terms of a standard bale of cotton using harvesting baling machines currently available, the total length of the wrapping unit is preferably between about 7 meters and about 21 meters, constituting about one to about three revolutions around the cotton bale, and the width of the wrapping unit at its widest is about 2.7 meters (though for example as illustrated in FIG. 1A, the tapered leading and trailing ends may be about 2.2 meters wide). While we will use 7 meter increments to discuss revolutions around a baled item, particularly cotton, as this is the cotton industry standard, this dimension may be different as desired, and indeed, in instances herein where the wrapping unit is the majority a reduced risk material such as paper, a revolution may only require 6 meters due to improved feeding efficiencies of the wrap using the harvesting machine such that additional length of wrap is not necessary to, for instance, account for any feeding issues. Depending on the strength of the wrap, the strength of the adhesives used to secure the wrap around the bale, the size of the bale, the material(s) used in the wrap, and other like variables, the wrap is typically sized to wrap a bale with about one to about three complete revolutions, though depending on these variables the actual length (and width, which is usually dependent on desired bale width) and number of part or full revolutions of wrap can vary. With reference again to wrapping unit 200, it is also contemplated that the transition zone 218 may be located anywhere along the length of wrapping unit 200. That is, leading side 202 including paper may have any length and trailing side 204 including plastic may have any length complementary to the length of leading side 202. For example, in the embodiment illustrated in FIG. 1A, wrapping unit 200 has a total length of approximately 21 meters, wherein leading side 202 (i.e., from leading edge 210 to transition zone 218) has a length of approximately 1.5 meters, and trailing side 204 (i.e., from transition zone 218 to trailing edge 230) has a length of approximately 19.5 meters. In this example, it is contemplated that leading side 202 may have any length measuring less than a distance between a wrap feed roll and a lower front gate roll of a baler. Further, while most examples discussed herein, including the present example, have a length of about 21 meters and a maximum width of about 2.7 meters, based on current wraps and machinery in use today, the length and width of a particular wrap may differ as desired and may be dependent upon the bale sizes formed by a particular machine, the type of object being baled and/or wrapped, the desired size of the bale, the materials used for the wrapping material, etc. Put another way, in the first revolution (or in the only revolution if the wrap only wraps around the baled item once), the leading side may account for about 20% or less of the overall length of the wrap in the revolution, while the trailing side accounts for about 80% or more of the overall length of the wrap in the revolution.

It is further contemplated, as noted above, that any length of wrapping unit 200 may include a tacky film or surface along any portion of the length thereon. For example, trailing side 204 may include a tacky film along at least a portion of its length and width. The tacky film may be included on a surface of trailing side 204. For example, using the embodiment of FIG. 1A as discussed above, the portion of trailing side 204 forming the second layer around the cotton bale may include the tacky film on the surface facing radially inward when the wrap is wrapped around the bale such that the tacky film disposed on the surface of the second layer contacts the first layer of the wrapping unit. In instances where the first layer of the wrapping unit also has a tacky film along at least a portion of its radially-outwardly facing surface (e.g., along at least part of leading side 202), such a configuration creates a tacky-to-tacky connection between the first layer and the second layer, which may be stronger than a tacky surface contacting a non-tacky surface and may provide a strength sufficient to overcome dirt and debris present within the first revolution of the wrap. Of course, any such tacky film on the first layer (e.g., along at least part of leading side 202) should not be on the radially-inwardly facing surface as such a tacky layer would contact the baled item which could cause the item, particularly an item such as cotton, to stick to the tacky film. Similarly, the energy-absorbent layer discussed above may also be used for one or both tacky surfaces. Further, such tacky surfaces may also be included on a portion of trailing side 204 that (if present) forms a third layer of wrap around the baled item, though such a tacky surface should be only on the radially-inwardly facing surface such that the tacky surface contacts the second layer underlying it once positioned on the bale. Again, similar to the other example above, the tacky surface of the second layer could, in this instance, instead be positioned on the radially-outwardly facing surface such that it contacts the tacky surface of the third layer. While the tacky surface(s) on a wrap may be of a consistent material and/or have consistent mechanical and chemical properties, tacky surfaces of varying materials, strengths, chemical properties, etc. are also envisioned. For instance, in a tack-to-tacky scenario, the opposing tacky surfaces may be formed of two different parts of an epoxy-like substance which, once brought together, form a secure adhesive or connection.

Such tacky-to-tacky contact among plastic layers may also allow for increased flexibility in removal of the wrapping material from the bale with decreased risk of cotton contamination by lost pieces of plastic commingling with the baled item. In other words, such a configuration may increase the thickness, stiffness, and/or weight of the plastic film, in that adjacent layers adhere to one another, such that it behaves similar to the high strength polymeric materials discussed above, thereby even further decreasing the risk of the cotton being contaminated by plastic. As with other examples herein, these benefits are evident where the baled item is cotton. Utilizing tacky films throughout the wrapping unit allows for increased adhesive between the layers of wrapping materials, particularly true where tacky surfaces of opposing layers contact one another. Removal of the wrapping material from the baled item typically requires cutting through the wrapping material at some location around the circumference of the baled item, with the intention of penetrating through all layers of wrapping material, e.g., through multiple layers of polyethylene film. Each of the layers of polyethylene film will be connected to one another via the tacky surface(s), such that all of the layers may be removed together. For example, for a wrapping material such as wrapping unit 200, trailing side 204 includes plastic wrap in a portion of the first layer in the wrapped configuration, which is adhered to the second layer formed completely of plastic, which is adhered to the third layer also formed completely of plastic. Further, for a wrapping material such as wrapping unit 300 (discussed below), trailing side 304 includes plastic wrap in the second layer in the wrapped configuration, which is adhered to the third layer.

Such a configuration may limit and/or prevent any piece of the wrap from separating from the rest of the wrapping material and commingling with the released baled item, such as the cotton heading into the ginning process. Further, even if some portion of the plastic does separate, it is likely to be a rather large, heavy and/or stiff piece given the connection between adjacent layers, such that it may be easily removed from the cotton by gravity, identification (visual, sensor-based, etc.), or the like.

Furthermore, in such configurations where the plastic layers are connected to one another, this allows greater flexibility to an operator in deciding where to sever the wrapping material to release the baled item. In particular, since most or all of the plastic contacts an adjacent plastic material, the wrapping material can be severed anywhere along the circumference of the wrapped bale and the plastic should remain in a single piece for removal from the baled item.

In any of the configurations described herein in which the plastic portion of the wrap is adhered to itself, including a wrap having a trailing side formed of plastic, as at least the second and third layer of the wrap, such that the second and third plastic layers are in contact with and adhered to each other for an entire revolution around the baled item, the wrapping material may be removed by cutting the wrapping material at any location along the surface of at least the second and/or third layers. Cutting the wrapping material may release the wrapping material from the baled item, and the wrapping material may be removed from the baled item in a single piece held together by the adhered plastic portions regardless of where the cut is made along at least the second and/or third layers. It is noted that this method for removing a wrap may be used, e.g., for wrapping unit 200 or wrapping unit 300.

As noted above, for purposes of minimizing contact with cotton, the tacky film may be excluded on the portion and face of the wrap which may come into contact with cotton, e.g., anywhere along the first revolution of the wrap, as the cotton or other object could adhere to the tacky film, which may undesirably waste cotton or create a problem for recycling the wrap. However, in some examples, the tacky film may be included in the first layer of the wrap on the face which faces radially outward, i.e., away from the cotton, so that the tacky film contacts the second layer of the wrap to increase friction between the first and second layers.

The transition zone 218, if present, may be adhesive, tape, or the like, which connects the first material of leading side 202 to the second material of trailing side 204. For example, one such material may be double-sided tape. In a particular example, the double-sided tape may be sufficiently elastic or flexible such that, upon application of a sudden force (e.g., release of the Z-Lock system, as known in the art), the double-sided tape can absorb at least a portion of this force to help prevent the leading side 202 from experiencing such a force. This may be particularly important where the leading side 202 is paper, where such a sudden force could cause a tear.

Alternatively, the energy-absorbent materials discussed above may be applied at the interface of these two materials, and melted to cause adherence between the two materials. In examples where the first material is paper and the second material is plastic film, tape or adhesive may be most suitable to ensure a stable or strong connection. In another example of a wrapping unit where a layer of polymer coating, such as a single sheet of LLDPE, extends along the entire length of the wrapping unit, a specific transition zone may be unnecessary, and instead, the single layer of LLDPE establishes a continuous wrapping unit by adhering to the first material along the leading side and adhering to the second material along the trailing side.

In other examples, FIG. 1B illustrates a wrapping unit 300 substantially similar to wrapping unit 200, whereby like numerals represent like structures. Wrapping unit 300 may extend from a leading edge 310 to a trailing edge 330 along longitudinal axis X having a total length measuring, for example, about 21 meters. Wrapping unit 300 may further have a leading side 302 including and/or formed of a first material, such as paper, measuring about 7 meters, and a trailing side 304 including and/or formed of a second material, such as plastic, measuring about 14 meters, leading side 302 and trailing side 304 having transition zone 318 located therebetween. As noted above, any portion of wrapping unit 300 may include a tacky film applied thereon, particularly trailing side 304. Further, while a taper is illustrated on leading side 302, as discussed above relative to wrapping unit 200, the taper (or another taper, or more than one taper) may also be positioned along trailing side 304.

In a specific example using wrapping unit 300, where the length of the leading side 302 is about 7 meters, this length is about equal to one circumference around a standard bale of cotton. Thus, in this example, the paper forms an entire surface of the wrapping unit in contact with the cotton. Minimizing or eliminating contact of the plastic (second material) with the cotton may help reduce or eliminate the risk of plastic particles falling into the cotton and contaminating the cotton.

In still further examples, FIG. 1C illustrates a wrapping unit 400 similar to wrapping units 200 and 300, whereby like numerals represent like structures, but without a transition zone. Wrapping unit 400 may extend from a leading edge 410 to a trailing edge 430 along longitudinal axis X having a total length measuring, for example, about 7 meters to about 21 meters (e.g., allowing for about one to about three revolutions around a bale of cotton). Wrapping unit 400 may further include and/or be formed of a first material, such as paper, along substantially the entire length of wrapping unit 400. As such, wrapping unit 400 includes a leading portion 412, a leading tapering portion 414 (if present), an intermediate portion 417, a trailing tapering portion 422 and a trailing portion 424. Thus, in one embodiment, the wrapping unit, such as unit 400, can be made completely of an innocuous material, for example, paper, such that substantially no, or completely no, plastic is included in the structure. Wrapping unit 400 may include tapering portions similar to wrapping units 200 and 300, or wrapping unit 400 may not include any tapering portions, having a consistent width throughout the entirety of the length of the wrapping unit. It is contemplated that a wrapping unit having substantially no plastic may nonetheless include, for example, a wrapping unit formed completely of paper with a thin polymer coating on one or both faces of the wrapping unit, which may provide the paper protection from weather-related elements. It is also contemplated that the wrapping unit may be formed of a paper chemically structured to be water resistant through the entirety of the paper wrap instead of, or in addition to, a wrap with a treated surface such as a coating, all as discussed above. Wrapping units 200, 300, 400 are illustrated in FIGS. 1A-C in a flattened configuration, and wrapping units 200, 300, 400 may also assume a wrapped configuration (i.e., wrapped around a bale of cotton) as illustrated further below.

Wrapping unit 400 may have a length to accommodate only a single layer of paper around an object, though preferably the wrapping unit 400 will have a sufficient length to provide some overlap such that the unit 400 can secure to itself and maintain a wrapped configuration—such as an area adjacent to the ends 410, 430 overlapping one another and securing to one another via an adhesive, tape, or the like. In one example, where the wrapping unit 400 is formed substantially from paper, a more significant overlap of the material may be helpful in providing additional friction between the wrapping material, providing additional strength to the wrap, and maintaining the integrity and shape of the wrapped object. As such, for instance, the wrapping unit 400 may have a length such that the wrap surrounds a perimeter of the object at least one and a quarter times (e.g., providing at least about 1 meters of overlap, preferably about 2-3 meters of overlap) to provide a larger amount of overlap of the wrapping unit 400 around the object.

It is also contemplated that any portion of the wrapping unit may be formed of plastic, paper, or a combination thereof. For instance, a leading side or a leading portion of a wrapping unit may be formed from both paper and plastic. For example, using FIG. 1A for ease of reference, leading side 202 of wrapping unit 200 may include a row or rows of paper alternating with a row or rows of polymer. The rows of paper and polymer may extend along the length of leading side 202 (i.e., parallel to longitudinal axis X) and alternate along the width, or the rows may alternatively extend across the width of leading side 202 (e.g., perpendicular to longitudinal axis X) and alternate along the length. In further examples, the alternating rows may extend at an angle transverse to longitudinal axis X. In still further examples, leading side 202 may be formed of paper and polymer alternating along both the length and the width of leading side 202, creating a checkerboard formation. The checkerboard formation may be formed with rows generally parallel and perpendicular to longitudinal axis X, or alternatively transverse to longitudinal axis X.

Wrapping unit 500 shown in FIG. 1D is generally similar to wrapping units 200, 300, 400, extending from a leading edge 510 to a trailing edge 530. Wrapping unit 500 includes a leading side 502, a middle portion 503, and a trailing side 504. Middle portion 503, as illustrated, is positioned between leading side 502 and trailing side 504, with middle portion 503 coupled to the trailing edge of leading side 502 and the leading edge of trailing side 504. Leading side 502 is coupled to middle portion 503 at a first transition zone 518a (e.g., at least a portion of each of leading side 502 and middle portion 503 covered by an adhesive as described above), and middle portion 503 is coupled to trailing side 504 at a second transition zone 518b. Leading tapering portion 514 is included on center portion 503 and trailing tapering portion 522 is included on trailing side 504. Leading side 502 is formed of, for example, paper, middle portion 503 is formed of, for example, plastic having a non-tacky film or having a tacky film on the surface facing away from the cotton in wrapped configuration, and trailing side 504 is formed of, for example, plastic having a tacky film on a surface facing toward the cotton in the wrapped configuration. However, any combination of paper, plastic, tacky film and non-tacky film is contemplated for each of leading side 502, middle portion 503 and trailing side 504. Additionally, any respective length is contemplated for each of leading side 502, middle portion 503 and trailing side 504. In some examples, leading side 502 may measure approximately 1.5 meters, middle portion 503 may measure between approximately 5 and 7 meters, and trailing side 504 may measure approximately 14 meters.

In yet another variation, the three sections, leading side 502, middle portion 503 and trailing side 504, may have a length suitable for a wrap that extends only about one revolution around the baled item. For instance, using the same overall bale dimensions noted above, leading side 502 may be approximately 1.5 meters, middle portion 503 may be approximately 5 and 7 meters, and trailing side 504 may be approximately 1.5 meters. In this example, the overall length of the wrap may be such that trailing side 504 overlaps at least leading side 502, which is particularly important where trailing side 504 may include a tacky film which should not contact the baled item (especially if it is cotton).

FIGS. 2A-2C illustrate various wrapping units wrapped around a bale of cotton according to several embodiments of the disclosure. For example, FIG. 2A illustrates wrapping unit 200 wrapped around cotton 10. In a wrapped configuration, wrapping unit 200 (having an exemplary length of about 21 meters) may extend approximately three revolutions around a bale of cotton. That is, a bale of cotton 10 may have a circumference or perimeter of about 7 meters, and therefore each length of a wrapping unit measuring about 7 meters will extend about one full revolution around bale of cotton 10. Leading side 202 is illustrated between leading edge 210 and transition zone 218, the length of leading side 202 marked by Xs in FIG. 2A. Trailing side 204 is illustrated between transition zone 218 and trailing edge 230 indicated by the length of wrapping unit 200 unmarked with Xs. Leading side 202, measuring approximately 1.5 meters, may extend a portion of a first revolution around cotton 10. Trailing side 204, measuring approximately 19-21 meters, may extend a remaining portion of the first revolution around cotton 10, forming a first layer of paper (e.g., from leading side 202) and plastic (e.g., from trailing side 204) contacting cotton 10. Trailing side 204 may further extend a full second revolution forming a second layer of plastic overlapping the first layer, and a full third revolution forming a third layer of plastic overlapping the second layer. Leading side 202 may be substantially or completely formed of paper, and trailing side 204 may be substantially or completely formed of polymer, such as plastic. As noted above, the second and third revolutions of wrapping unit 200 forming second and third layers, respectively, may include a tacky film applied thereon to one or both surfaces of the wrapping unit, which may increase the friction of the second and third layers with surrounding layers and minimize loosening or unraveling of the wrapping unit 200, thereby maintaining the integrity and shape of the wrapped bale. It is also contemplated that only a portion of trailing side 204 includes a tacky film, such that, for example, only the second layer or only the third layer, or only a portion of either layer, includes the tacky film, while conversely, tacky areas on both layers may contact one another, thereby increasing the friction between adjacent revolutions of wrap.

In some examples, the second layer of the wrap may include a tacky portion on the surface facing radially inward toward the cotton covering the leading side denoted by Xs in FIG. 2A. However, this design can prove challenging because, if the tacky surface starts too early, and the bale is particularly large, the tacky surface may come into contact with the baled item, which if it is cotton or something similar could damage the cotton, as discussed above. As such, if such a tacky surface is going to be applied to the wrapping material, such a surface feature should begin at a location that is at least slightly more than one revolution—using the example of a standard cotton bale again, perhaps at about 9 meters. This way, if the circumference of the bale is 8 meters, the risk of the tacky surface contacting the baled cotton remains low. Starting the inwardly-facing tacky layer at about 9 meters along the length of the wrap can still provide sufficient overlap to provide the possible benefits to the wrap of added strength and stability to the wrapped bale since this tacky layer would still contact the inner layer of wrap (whether paper or paper and plastic) along much of its length.

As noted above, a substantial portion of contamination is usually caused by the leading portion of the wrapping unit. Typically, the leading section of a wrapping unit, for instance about the first 1.5 meters, is often loose and not in contact with any tacky layer of wrap. As such, if the wrap is cut in the wrong location, i.e., at a location on the circumference within that about 1.5 meters of the leading edge, that portion of the wrap could end up loose and fall away along with the cotton into the cotton gin processing equipment. The use of an innocuous first material, such as paper, as discussed above, may alleviate this issue in that, should a piece of this material end up in the cotton (or other product), it does minimal if any harm because the paper can be easily removed by ginning, spinning, and/or any other cotton processing machinery. In the event the paper still remains in the cotton until the fabric stage, the use of paper may alleviate issues in that the paper can absorb dye such that, for example in the manufacture of a dyed cotton shirt, the paper particles will take on the same color as the surrounding cotton, resulting in a superior product as opposed to a cotton shirt which includes a particle of plastic which does not absorb dye and thus appears as an undyed spot on the shirt. For instance, this leading side 202 made of the first material may have a length of about 1.5 meters, and will establish the initial contact of wrapping unit 200 to cotton 10 when deploying wrapping unit. In one nonlimiting example of this structure, as illustrated in FIGS. 1A and 2A, the first 1.5 meters wrapped around cotton 10 will be formed of paper while the remaining portion of wrapping unit 200 to contact cotton 10 within the first revolution may be formed of plastic. Continuing with this example, wrapping unit 200 will then overlap itself with a second and third revolution with trailing side 204 which may be formed of plastic.

In another example, the first material may be a high strength polymeric material that has sufficient stiffness such that, should any portion of the material end up in the cotton (or other object), it can be removed from the cotton by the normal processing. As discussed above, such a high strength polymeric material should be substantially rigid and dense such that it does not shred into overly small pieces, and may be easily separated and removed via the normal processes such as using the machinery at the gin (e.g., cylinder cleaner, stick machine, or lint cleaner) or spinning machines (e.g., carding, drawing, or winding), as known in the art. Such high strength polymeric materials may thus be used as the first material in any of the embodiments discussed herein, even as the primary or substantially only wrapping material used in wrapping unit 400.

In an example for producing processed cotton raw material having no or substantially no plastic contamination, a cotton bale (or other baled item) may first be wrapped by a wrapping material having any of the configurations described in the disclosure herein, the wrapping material therefore at least having a paper portion adjacent the leading end of the wrap, and wherein the wrapping material may also have a plastic portion adjacent the trailing end of the wrap. The wrap may be cut at any location along the wrapping material to release the wrap from the cotton bale, and the wrap may then be removed from the cotton bale. During the removal process, a portion of the wrap, such as the paper portion, may be left behind and remain with the cotton bale. The material remaining with the cotton bale may be separated from the cotton bale using any of the processes described herein, such as removal by hand or removal through the cotton processing in the ginning equipment, cotton separator and/or spinning mill, and readily removed thereafter. As such, the wrapping material is removed, either completely or nearly completely, leaving behind minimal if any plastic or paper mixed in with the processed cotton. Specifically, it is anticipated that the wrapping materials of the present disclosure will reduce cotton contamination in processed cotton caused by the wrapping materials in use today (which already achieves a significantly low rate of cotton contamination) by at least 50%, as recent research anticipates achieving a reduction of up to 80%, if not more.

In particular, the various embodiments described herein, where the leading end of the wrapping unit is paper, stiffened polymer (e.g. thick polyethylene), or the like, allows for easier identification of the wrapping material in the cotton, for hand removal, and/or easier separation by the cotton processing equipment (or other processing equipment depending on the baled item). This is because these leading end materials should, in the event they separate from the rest of the wrapping material, remain in fairly large pieces which can easily be separated along with other cotton plant materials during normal cotton processing. Similarly, the inclusion of tacky films on the plastic portions (e.g., such that the plastic wrapping material layers contact and adhere to one another) also helps maintain plastic pieces, should they separate from the rest of the wrapping material, in relatively large pieces which, again, can easily be separated during normal cotton processing. Specifically, the tacky surfaces of the wrapping material sticks to adjacent revolutions of the wrapping material, which may cause the adjacent wrapping layers to adhere to one another. This construct may be more robust than a single layer of plastic wrapping material, which may result in not just larger pieces, but thicker pieces (i.e., because adjacent revolutions of wrapping material around a bale may remain adhered to one another). Thus, the use of wrapping materials that are less likely to shred or detach in the first place, or if they do, remain in fairly large and/or thick pieces which can be easily removed, versus other wraps that may be more susceptible to being cut into smaller, difficult to separate pieces, may result in a cotton product having little to no contamination by wrapping material.

Utilization of wrapping unit 200 having a leading side 202 measuring at least about 1.5 meters and formed of paper may provide a number of benefits to the wrap. First, this structure may substantially reduce the amount of contamination caused to the cotton (or other baled material), or at least reducing the amount of troublesome contaminants (e.g., those contaminants that do not accept dye), while also, if a second material is present, exploiting the low cost, high efficiency, durable, and effective plastic material for trailing side 204, which will form at least one outer layer around both the paper portion of the wrap and the baled material. Furthermore, due to its thickness, the reduced risk material of the leading side of the wrap, such as paper or a high strength polymeric material, may be more rigid and stiffer than its plastic counterpart, which may, e.g., make it easier to push the wrap through its path in the wrapping machine and allow leading portion 212 of wrapping unit 200 to more reliably initiate the wrapping process around cotton 10. The increased thickness and rigidity of paper relative to typical plastic film may also reduce the potential for bunching at the paper portion of the wrapping unit as the wrap is fed into the baling machine, also reducing the likelihood of unintended folds or crinkles formed in the wrap. After an initial portion of the wrap (e.g., the paper portion) is fed through the baler in an intended flat, unfolded, uncreased orientation, the likelihood improves of the subsequent plastic portion to follow suit in the same manner. Still further, the coefficient of friction of paper may improve its ability to latch onto the baled material and/or the baler belts to help initiate the wrapping process. Such qualities promote efficient feeding of, for example, wrapping unit 200 through the baling machine. Improved feeding may also allow for a reduced length of wrapping unit 200, thus using less material. Still further, the reduced use of plastic (relative to a similar wrapping unit formed completely of plastic) may decrease the labor demands in handling the wrapped cotton bales. A bale wrapped in paper may require less care at the cotton gin and paper may be easier to dispose of than plastic, thus lightening the burden on the task of disposal when the cotton is removed from the bale. And of course, given that the paper portion of the wrapping unit can be biodegradable, or otherwise not harmful to the product quality should it remain in the product (or at least substantially less harmful than plastics are), less oversight of the cotton (or other material) entering the cotton gin (or other processing unit) may be required.

Further, the use of such rigid and stiffer materials may allow for denser bales to be formed since the wrapping unit including such materials may be able to accommodate and hold a denser bale having a greater amount of cotton in the bale. Such materials included in the wrapping unit allow for added strength in the wrapping unit which can, for instance, maintain its integrity around the increased amount of cotton, as well as maintain the round shape of the bale (e.g., prevent “squatting” where the bottom of the bale flattens on the ground) even while the bale is sitting in the field or gin, or while being handled.

FIG. 2B illustrates wrapping unit 300 wrapped around cotton 10. As described above relative to FIG. 1B, wrapping unit 300 has a total length of approximately 21 meters, and thus revolves approximately three revolutions around cotton 10. Leading side 302 is illustrated between leading edge 310 and transition zone 318, the length of leading side 302 marked by Xs in FIG. 2B. Trailing side 304 is illustrated between transition zone 318 and trailing edge 330 indicated by a length of wrapping unit 300 unmarked with Xs. Leading side 302 may be substantially or completely formed of paper, and trailing side 304 may be substantially or completely formed of polymer, such as plastic. As noted above, leading side 302 has a length measuring about 7 meters, and at that length wraps approximately one full revolution around cotton 10, forming a first layer of paper around cotton 10. As such, only leading side 302 may be adjacent to and/or configured to make direct contact with cotton 10. As shown in FIG. 2B, and as discussed further below, the formation of an exact single revolution around cotton 10 is dependent upon a consistently sized cotton bale in the standard harvesting machines used today (discussed below), which in practice is not always the result due to differences in cotton plants, harvesting density, humidity or moisture in the cotton, environmental temperature, etc. As such, to help ensure a consistent first layer of paper is formed onto each bale regardless of variations in bale size, the leading side 302 may be slightly longer than 7 meters. As such, while a length of leading side 302 of about 7 meters is typically what is needed to form a first wrapping layer of paper, the wrapping unit 300 may have a leading side 302 length of anywhere from about 7 meters up to about 10 meters to provide some added paper in the event a bale is slightly larger than normal. Of course, as noted elsewhere herein, an overlap of paper may also impart a benefit to the wrapping unit in added strength and holding power once wrapped around the cotton. The first layer of the wrapping unit may be a large contributor to cotton contamination, and wrapping unit 300 may further substantially reduce the risk of contamination, along with providing each of the other benefits described above with reference to wrapping unit 200. Trailing side 304 may overlay leading side 302 in the wrapped configuration, such that trailing side 304 begins generally where the second revolution around cotton 10 begins and wrapping unit 300 begins to overlap itself. The second revolution may form a second layer formed of plastic overlapping the first layer, and the third revolution may form a third layer formed of plastic overlapping the second layer. As noted above, any portion of trailing side 304 may include a tacky or non-tacky film applied thereon.

Continuing with wrapping unit 300 of FIG. 2B, in some examples, transition zone 318 may be shifted slightly farther toward trailing edge 330, e.g., about 2-3 meters, increasing the length of leading side 302 and decreasing the length of trailing side 304. That is, leading side 302 formed of paper may measure approximately 9-10 meters and trailing side 304 formed of plastic may measure approximately 11-12 meters. As such, based on the size of a normal cotton bale 10, leading side 302 formed of paper will extend one full revolution (e.g., accounting for approximately the 7 leading meters of the wrapping unit 300) and include approximately 2-3 meters in the second layer overlapping the first layer before transitioning to trailing side 304. The overlap of the leading side 302 over itself may result in increased friction due to paper-on-paper contact relative to plastic-on-paper contact. Increased friction may eliminate or reduce relative motion between the first and second layers of the wrapping unit to maintain a firm hold of the wrapping unit around the cotton and sustain a greater cotton density within the bale, for instance, as the paper provides greater strength to the finished, wrapped baled object, than the plastic. In other words, the addition of a significant length of paper provides for a stronger wrapping material than a wrap formed entirely of LLDPE. Such a wrap of hybrid material (e.g., paper and plastic), or even entirely of paper, allows for a larger amount of cotton to be placed into each wrapped bale, which typically may not be possible as the added cotton density may damage or overcome the wrapping forces applied by a traditional plastic wrap. Further, using wrapping united including paper provides greater strength to the wrapped bale once it is on the ground or being moved around or transported as the paper may be less susceptible to puncture or other damage. Still further, the paper wrapping unit (or hybrid paper-plastic wrapping unit) may help maintain the shape and integrity of the wrapped bale better, e.g., to keep the cylindrical shape true to limit the amount of the bale touching the ground which helps lifts more of the cotton away from standing water on the ground or the like. Still further, the ability to add more cotton into each wrapped bale means less wraps used per unit of cotton, and thus, less wrap cost per unit of cotton.

In other examples, a wrapping unit may include a leading side measuring approximately 14 meters, and a trailing side measuring approximately 7 meters. The leading side may be formed of paper and the trailing side formed of plastic. In such examples, the paper would extend approximately two revolutions around a cotton bale forming the first layer contacting the cotton and the second layer overlapping the first layer. Further in such examples, the plastic would extend approximately one revolution around the cotton bale forming the third layer overlapping the second layer.

FIG. 2C illustrates wrapping unit 400 wrapped around cotton 10. As described above, wrapping unit 400 extends from leading edge 410 to trailing edge 430 having a total length of approximately 21 meters, and thus revolves approximately three revolutions around cotton 10. The full length of wrapping unit 400 is formed from paper, as marked by Xs along the length of wrapping unit 400. As such, wrapping unit 400 extends a first revolution around cotton 10 forming a first layer of paper adjacent cotton 10, a second revolution around cotton 10 forming a second layer of paper overlapping the first layer of paper, and a third revolution around cotton 10 forming a third layer of paper overlapping the second layer of paper. Thus, wrapping unit 400 does not include any plastic, which may further reduce or eliminate the risk of contamination of cotton 10 along with each of the other benefits described above with reference to wrapping unit 200.

In some examples, the wrapping unit may be completely formed of paper, as described above, but may extend approximately one revolution around the bale. As such, the wrapping unit may have a length of approximately 7 meters, and may have a paper thickness greater than that of wrapping unit 400 such that, e.g., the thickness of the wrapping unit in the present example (forming one layer around the bale) is the same or substantially the same as the total thickness of wrapping unit 400 having three layers around the bale. One single layer of greater thickness as described in the present example may be more robust than three layers of thinner paper. An additional benefit of paper wrap (which applies to any of the embodiments described herein) is that the stiff nature of the material makes possible an increased density of the cotton within the wrap, which may increase the amount of cotton that can be included in a single bale, and/or maintain a reduced size for each bale to facilitate ease of hauling to the gin. Reducing the size of the bale reduces the surface area with which the bale contacts the ground, thereby creating less exposure to standing water on the ground.

It is contemplated that for a wrapping unit measuring about 21 meters, the length of the wrapping unit formed of paper may range from about 0.1 meters up to the full length of the wrapping unit, e.g., about 21 meters. It is further contemplated that a wrapping unit having any other total length may have a paper length substantially proportional to the lengths noted above. In certain embodiments, the paper portion of the wrapping unit may have a thickness between about 100 and about 250 micrometers, and preferably a thickness of about 210 micrometers. The paper portion may have any color. In certain embodiments, the paper portion of a wrapping unit may have a weight between about 50 grams per square meter and about 200 grams per square meter. In certain embodiments, the paper portion of a wrapping unit may have a tear property of approximately 100-400 grams according to ISO 1974, depending on base weight and type of the paper. In certain embodiments, the paper portion of a wrapping unit may have an elongation factor (i.e., the material may stretch) between about 0.1% and about 50%. For example, the paper itself may be capable of stretching about 0.1-15%, and a wrap formed of the crepe paper described above in combination with the elongation property of the paper may be capable of stretching up to about 50%. As noted above, a preferred amount of stretch may be about 8%. In certain embodiments, the paper portion of a wrapping unit may have a tensile strength of approximately 4-25 kgᵣ/cm according to ISO 1924-3. In certain embodiments, the paper portion of a wrapping unit may have a bursting strength between about 350 kPa and about 1500 kPa. In certain embodiments, the paper portion of a wrapping unit may define a width between about 1.2 meters and about 2.7 meters. It should be noted that in some examples, a wrapping unit may have a consistent width throughout the full length of the wrapping unit, whereas in other examples, such as wrapping units 200, 300 and 400, the width may vary at different locations along the length of the wrapping unit, each width falling within the above-noted range.

It is contemplated that for a wrapping unit measuring about 21 meters, the length of the wrapping unit formed of plastic may range from about 0 meters to about 20.9 meters. It is further contemplated that a wrapping unit having any other total length may have a plastic length substantially proportional to the lengths noted above. The plastic portion may be clear or pigmented with any color. In certain embodiments, the plastic may have a thickness between about 40 microns and about 300 microns. In certain embodiments, the plastic may have an Elmendorf tear property according to ASTM D 1922-00a in the machine direction (MD) between approximately 100 and 1000 grams, and a tear property in the transverse direction (TD) between approximately 300 and 3000 grams. In certain embodiments, the plastic may have an elongation between about 20% and about 1000%. In certain embodiments, the plastic may have a modulus between about 100 MPa and about 2000 MPa according to ASTM D-882. In certain embodiments, the plastic may have a puncture resistance (measured as the amount of work to break) between approximately 600 newton-millimeter and approximately 10,000 newton-millimeter according to ASTM D 5748-95. In certain embodiments, the plastic may have a tensile strength between approximately 10 MPa and approximately 600 MPa.

In some embodiments, and particularly for wrapping unit 400 which includes an outer layer of paper (since the wrap is formed completely of paper), the innocuous wrapping material (or otherwise non-plastic wrapping material) may be treated with a coating, additive, film, or the like to enhance its strength and durability properties, particularly as to its weather durability in terms of, for instance, UV-radiation and precipitation. For instance, the paper may be formed with and/or coated with a material which sheds water to protect the paper and the object within the paper, such as cotton, from rain, snow and ground moisture. Further, the paper material and/or coating may have microscopic pores that allow water vapor inside the bale (e.g., from wet cotton) to escape through the pores. In some embodiments, the paper may be formed with increased thickness and able to withstand higher tension to be wrapped tightly around the cotton, while also providing a thicker barrier between the cotton and external elements. In some embodiments, the length of paper may be multi-layered, forming at least 2-ply paper to be wrapped around cotton. In such embodiments, the added layers may provide the cotton with added protection, and a 2-ply layer may continue to provide protection and contain the cotton with a rip in one of the layers.

In some examples, a plurality of wrapping units may be releasably connected together at their leading and trailing ends to form a sequence of wrapping units for effective deployment from a cotton baling machine. Each wrapping unit may constitute at least one complete wrapping cycle. A supply roll (referred to herein variously as a supply roll, a wrap roll, a wrapping unit roll, or simply a roll) of wrapping material comprises several wrapping units, which are held and released at their leading and trailing ends. For example, the leading and trailing ends of each wrapping unit may be formed into a Z shape to produce a Z-lock system, found in a current wrapping product TamaWrap® (Tama Group, Israel) and as generally described in greater detail in U.S. Pat. No. 6,787,209, the entire disclosure of which is herein incorporated by reference. Such a Z-lock system may hold the wrapping portions together during manufacturing and also easily release the wrapping portions at the completion of a wrapping cycle. At the completion of a wrapping cycle, the leading or trailing end of at least one wrapping unit may retain an adhesive layer that seals the item being wrapped.

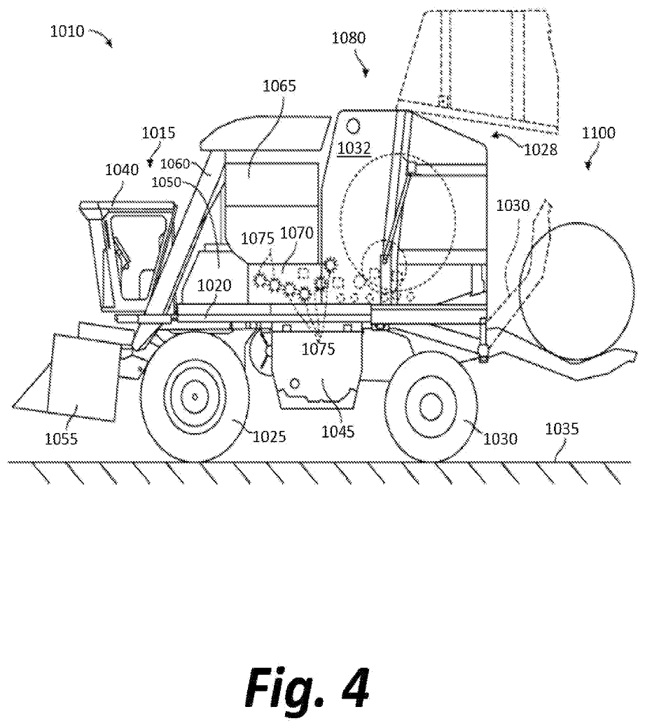

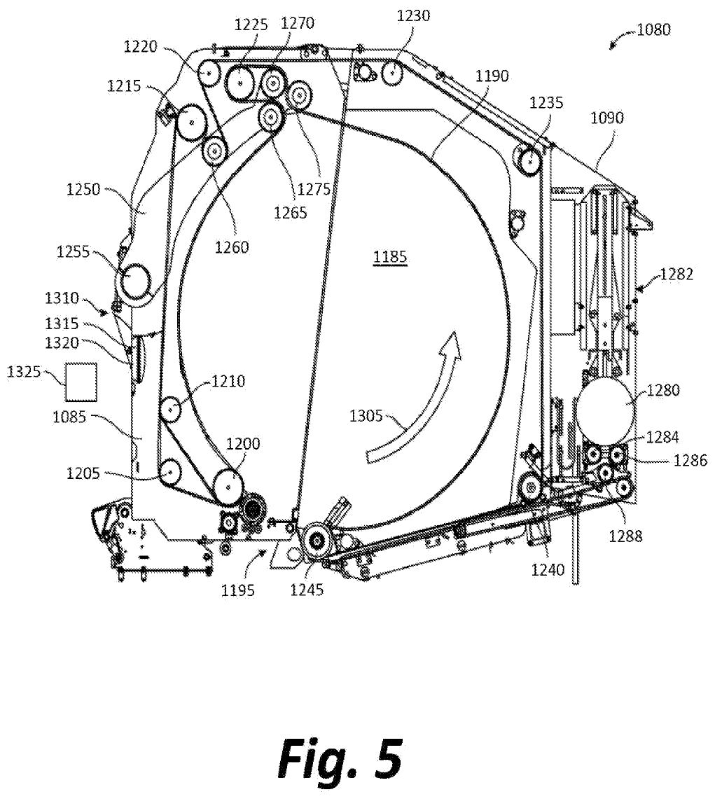

FIG. 3A shows the formation of a releasable bonding between two wrapping units, such as leading wrapping unit 400a and trailing wrapping unit 400b. In a conventional wrapping unit, such as the embodiment described in U.S. Pat. No. 6,787,209, a leading wrapping unit formed of plastic has a release layer coupled to a lower surface of the trailing end by an adhesive layer. Further, a leading end of a trailing wrapping unit also formed of plastic is configured in a V-fold with an adhesive layer coupled to the exposed surface of the V-fold, a substrate layer overlying the adhesive layer. The trailing end of the leading wrapping unit is releasably pressed over the V-fold of the trailing wrapping unit such that the release layer contacts the substrate layer and is bonded to the adhesive through the substrate layer.

According to the present disclosure, one embodiment of a releasable connection between wrapping units 400a and 400b (using wrapping portion 400 as an example) is illustrated in FIGS. 3A-3B. The illustrated example includes a release layer 460 which may be a silicone layer attached to a leading end 412b of wrapping unit 400b. As the wrapping material itself is paper, or like material, the silicone layer can be applied directly to the wrapping material without the need of an intermediate paper-like backing between the silicone and the plastic wrapping material, thereby simplifying the structure and its manufacture while also reducing the thickness of the leading end of the wrapping unit which may benefit feeding consistency into the baling machine. In another example, instead of silicon, this release layer 460 can instead be paraffin wax or other material that allows release of an adhesive therefrom. A further possibility includes a release layer that is a wax or like coating that may be included on a paper layer for purposes of paper integrity and durability, as noted herein, which may further simplify the structure and its manufacture. An adhesive 462 (e.g., an acrylic adhesive) overlies the release layer 460 and is applied adjacent the lower surface of trailing end 424a of wrapping unit 400a. Adhesive layer 462 will ultimately adhere trailing end 424a onto the length of wrapping unit 400a to finally seal the wrap around a baled item. When leading wrapping unit 400a is releasably connected to trailing wrapping unit 400b, as shown in FIGS. 3A-3B, release layer 460 is configured to contact the exposed folded surface of V-fold 440b of trailing wrapping unit 400b. Such a connection may allow for a simple, clean, and efficient separation of leading wrapping unit 400a from trailing wrapping unit 400b during the wrapping process. That is, leading wrapping unit 400a may be deployed from a roll of wrapping units to be applied to the perimeter of a bale of cotton 10 and wrapped around cotton 10. The rotation of the roll may be slowed or stopped while deployment of the leading wrapping unit 400a around cotton 10 continues, thus causing trailing portion 424a of leading wrapping unit 400a to translate in the leading direction relative to trailing wrapping unit 400b. Such relative translation may unfold V-fold 440b and separate trailing portion 424a of leading wrapping unit 400a from leading portion 412b of trailing wrapping unit 400b. It should be understood that the process may continue in a substantially identical manner for remaining wrapping units disposed on the wrapping unit roll.

While as illustrated in FIGS. 3A-3B, the leading end 412b of trailing wrapping unit 400b includes the V-fold 440b, the Z-lock construct may be reversed—an embodiment of such a variation is illustrated in FIG. 3C (while FIGS. 3A-3B illustrate a wrap with a feeding direction going to the left, such that wrapping unit 400a is moving into the baling chamber of a harvester, FIG. 3C illustrates a wrap with a feeding direction going to the right, such that wrapping unit 400a′ is moving into the baling chamber of the harvester). FIG. 3C illustrates the V-fold positioned on a trailing end 424a′ of a leading wrapping unit 400a′ (and of course the V-fold can be positioned upward, as illustrated, or downwards, on either wrapping unit 400a, 400b in other variations). Positioning trailing end 424a′ into a V-fold may allow leading end 412b′ of a trailing wrapping portion 400b′ to remain flat which could be beneficial as the aforementioned leading end materials (e.g., paper or thickened polymer) may be thicker than the plastic forming the trailing end 424a′, and thus may assist in more efficient packing of the wrapping units onto the roll prior to use; similarly, the leading end materials selected could then be even thicker and/or stiffer. A further potential benefit would be that moving the V-fold to the plastic trailing end 424a′ eliminates a fold in the paper leading end 412b′ as such a fold in the paper portion could cause a tear in the paper portion during feeding and/or during separation of the Z-lock. Another potential benefit would be that the paper leading end 412b′, being positioned flat around the roll (i.e., without a fold), may achieve a curvature “memory” in that the curvature of the paper leading end 412b′ positioned around the roll may remain even once the leading end 412b′ unfurls from the roll. Such “memory” may be favorable in helping the leading end 412b′, and in particular the leading edge of leading end 412b′, through the harvester machinery, e.g., through the lower gate roll and into the baling chamber. On the other hand, positioning the V-fold on the paper leading end may prevent the known issue of “blocking” in the existing wraps, which occurs when the opposing sides of a folded plastic portion stick together enough to cause a jam in the machine. In this example, the folded paper leading end should not stick together, perhaps lessening the risk of a “block” from occurring.

Continuing with the embodiment of FIG. 3C, a release layer 460′ is positioned on leading end 412b′, and an adhesive 462′ is positioned on trailing end 424a′, both of which are similar to those described above as to FIGS. 3A-3B. This embodiment may also include a temporary connection 480′ between the two parts of trailing end 424a′ forming the V-fold, which may help maintain the V-fold as the leading wrapping portion 400a′ and the Z-lock connected to the trailing wrapping portion 400b′ extend from the roll of wrapping material and enter into the baling mechanisms of a harvesting machine. Since of course the V-fold is open to the leading direction (e.g., the direction of travel of the wrapping material into the baling area of a harvester), the surrounding machinery may catch the V-fold and cause it to open up, potentially leading to premature exposure of the adhesive 462′, jamming of the wrapping material in the machine, or the like. The temporary connection 480′ may help maintain the V-fold shape as the wrapping material travels through the surrounding machinery. Connection 480′ may be a portion of plastic (e.g., the same plastic forming the trailing end 424a′), an adhesive, a tack or pin weld, a laminate of one or more adhesives similar to release layer 460′ and adhesive 462′, low-adhesion adhesives facing one another, or the like.

In examples in which a trailing portion of the wrapping unit is formed of plastic, such as wrapping units 200 and 300, a substantially similar method may be used to apply the wrapping unit from a roll of wrapping units to a bale of cotton. A leading wrapping unit in a sequence of wrapping units on a roll may then be applied to the perimeter of an object, such as bale of cotton 10. Leading side 202 formed of paper may then be applied directly to the bale of cotton 10 along a portion of the perimeter of cotton 10, followed by trailing side 204 formed of plastic being applied directly to bale of cotton 10 for at least the remaining exposed perimeter of cotton 10 until the first revolution is complete. Trailing side 204 of wrapping unit 200 may then continue to be applied to bale of cotton 10, forming a second layer of plastic overlapping both the paper and plastic portions of the first layer, and a third layer of plastic overlapping the plastic second layer.

Similarly, a sequence of a plurality of wrapping units 300 may be releasably bonded in the same manner as wrapping units 200 and 400. While applying a leading wrapping unit 300 to bale of cotton 10, leading side 302 formed of paper may be directly applied to cotton 10 along the exposed perimeter of cotton 10 and wrapped approximately one full revolution around cotton 10 forming a first layer. Leading side 302 will be followed by trailing side 304 formed of plastic, trailing side 304 wrapped over the first layer beginning approximately where a second revolution around cotton 10 begins. Trailing side 304 may wrap in a second and third revolution forming a second layer formed of plastic covering the first layer formed of paper and a third layer formed of plastic covering the second layer.

In another embodiment, instead of or in addition to the Z-lock configuration, adjacent wrapping units on a roll may be connected to one another via a perforation or other connection between a trailing edge/end of one wrap and a leading edge/end of a subsequent wrap.

In yet another embodiment, rather than the wrapping material in the above embodiments pre-defined into wrapping units or portions connected to one another by a Z-lock and/or perforations or other connections, the wrapping material may instead be a continuous length of material. As such, instead of individual wrapping units coupled to one another, and thus each unit or portion having a defined length, the continuous wrapping material of this embodiment may be cut anywhere along its length such that the length of a particular unit or portion, cut from the continuous wrapping material, may have any length desired. For instance, the wrapping material may be a continuous length of paper with a polyethylene coating along all or a portion of the length of paper (e.g., intermittent coating, continuous coating, etc.). A cut can be made by the machine or a user with a cutting means, such as a knife, scissor, etc., anywhere along the wrapping material once the desired length of material around a bale is achieved.

In still another embodiment, the wrapping portions including the first material and the second material, respectively, may be independent of one another such that, for instance, the first material may be on a first roll and the second material may be on a second roll separate from the first roll. This would be as opposed to the wrapping units of, for example, FIGS. 1A-1D which are formed of both first and second materials and positioned on a common roll. Continuing with this embodiment, the roll of first material (e.g., paper) may first be applied to the bale to form a wrap of at least part of one revolution around the bale of the first material, and then the roll of second material (e.g., plastic film) may be applied to the bale to form another portion of the wrap of at least part of one revolution around the bale, and optionally, around at least part of the first material already applied to the bale. In a specific example, the first material forms at least one revolution of wrapping material around the bale, and the second material forms at least one revolution of wrapping material around the first material previously wrapped around the bale.

Continuing with this embodiment, the first material and/or second material may have any of the features discussed above to achieve securement around the bale. For instance, either or both materials may include one or more tacky surfaces to provide added friction between adjacent wrapping layers around the bale. Also, the end(s) of the first material may include one or more adhesives for securement to the end(s) of the second material. In another example, the first and second materials may not include any adhesive for securing to one another, and instead, at least one of the first and second materials may include an adhesive area for securement to itself—in a particular variation, an adhesive area may be positioned on the end of the second material wrapping portion such that it adheres to itself once positioned around the bale and first material to ultimately secure the bale, first material and second material into a formed wrapped bale.

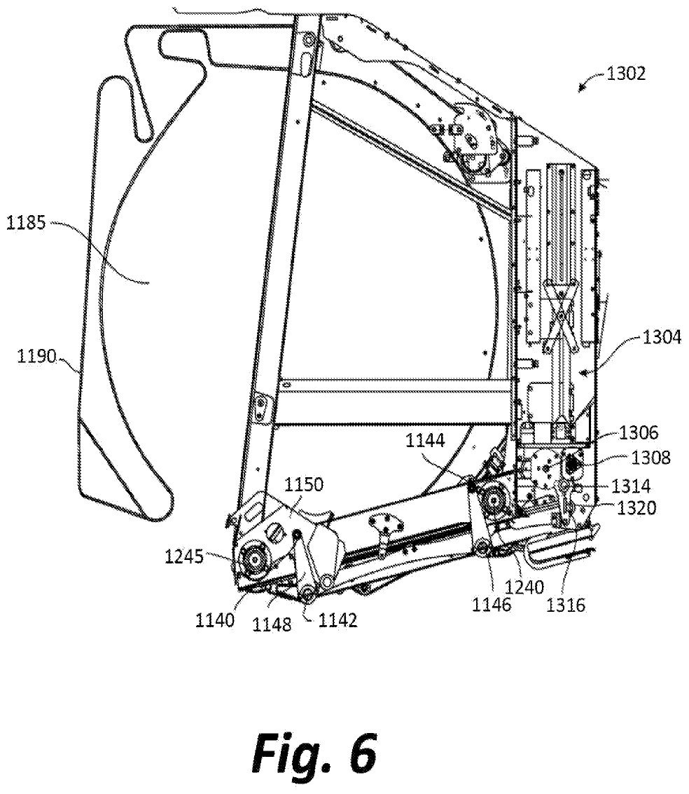

The various wrapping materials discussed herein may be used with various machinery commonly used for collecting and organizing items to be baled. Continuing with the primary example of using the wrapping materials for wrapping cotton bales, one such machine is a cotton harvester, such as those currently used including those manufactured and sold by Deere & Co., such as cotton harvester models 7760, CS690, CS770, CP690 and CP770. FIGS. 4-7 illustrate representative features of an exemplary cotton harvester. In this example, FIG. 4 illustrates a harvester 1010 according to one embodiment. The illustrated harvester 1010 is a cotton harvester 1015. Alternatively, the harvester 1010 may be any type of work machine that utilizes a wrapping assembly.

The harvester 1010 includes a chassis 1020. The chassis 1020 is supported by front ground engaging members 1025 and rear ground engaging members 1030. Although the front ground engaging members 1025 and rear ground engaging members 1030 of the work vehicle 1010 are depicted as wheels, other supports are contemplated—for example, tracks. The harvester 1010 is adapted for movement through a field 1035 to perform a task, such as harvesting a crop. As examples only, work vehicle 1010 may be configured to harvest cotton, corn, soybeans, canola, stover, hay, alfalfa, or other agricultural crops. An operator station 1040 is supported by the chassis 1020. An operator station 1040 is supported by the chassis 1020. A power module 1045 may be supported below the chassis 1020. Water, lubricant, and fuel tanks, indicated generally at 1050, may be supported on the chassis 1020.

A harvesting structure 1055 is coupleable to the chassis 1020. The illustrated harvesting structure 1055 is configured to remove cotton from the field 1035. Alternatively, the harvesting structure 1055 may be configured to remove other crop. An air duct system 1060 is couplable to the harvesting structure 1055. An accumulator 1065 is coupleable to the air duct system 1060. The accumulator 1065 is configured to receive cotton, or other crop, from the harvesting structure 1055 via the air duct system 1060. A feeder 1070 is coupleable to the chassis 1020. The feeder 1070 is configured to receive cotton, or other crop, from the accumulator 1065. The feeder 1070 includes a plurality of rollers 1075 configured to compress the cotton, or other crop, and transfer the cotton, or other crop, to a round module builder 1080. The round module builder 1080 has a baler gate 1028 and a baler front 1032.

While a round module builder 1080 is shown and described as part of a cotton harvester 1015, this disclosure is not limited to such an application of a module builder. More specifically, other embodiments considered for this disclosure include, but are not limited to, a pull type round baler. A pull type round baler may not include a chassis, header, air system, and other components shown on the cotton harvester 1015. Rather, the pull behind round baler may have a hitch, wheels, and a crop pickup assembly coupled to the round module builder. A person having skill in the relevant art understands how the teachings of this disclosure can be applied to any round-type baler or module builder and this disclosure is not limited in application to the cotton harvester 1015 shown and described herein.

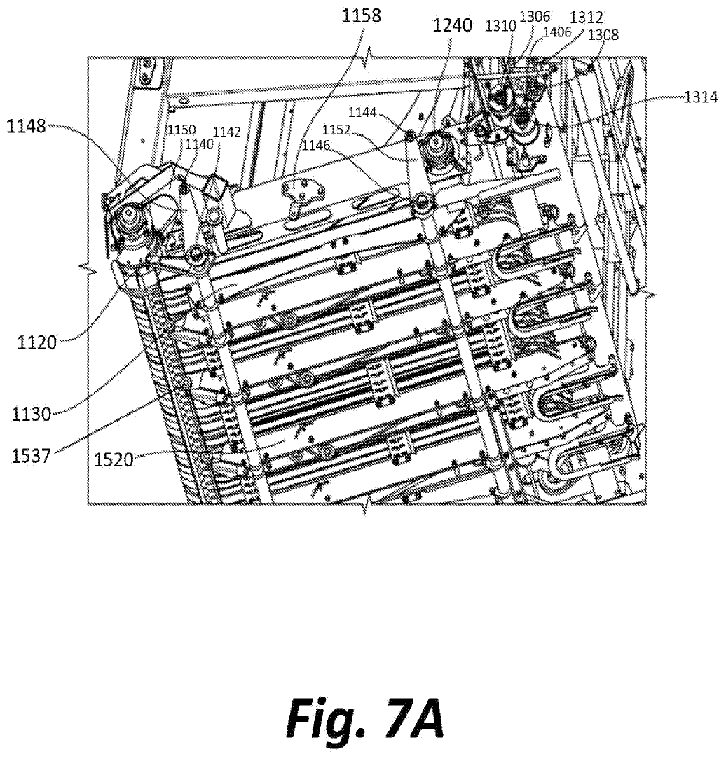

Referring to FIG. 5, a module-forming chamber 1185 may have a plurality of belts 1190 define the circumference of the module-forming chamber 1185. The plurality of belts 1190 are supported in a side-by-side relationship across a support roll arrangement comprising a plurality of fixed rolls and a plurality of movable rolls. Specifically, proceeding clockwise from a chamber inlet 1195 where crop enters the module-forming chamber 1185, the fixed rolls include a lower drive roll 1200, a first separation roll 1205, a second separation roll 1210, an upper drive roll 1215, an upper front frame roll 1220, an upper rear frame roll 1225, an upper front gate roll 1230, an upper rear gate roll 1235, a lower rear gate roll 1240, and a lower front gate roll 1245 all coupled for rotation within the round module builder 1080.

In FIG. 5, a conventional pair of transversely spaced belt tensioning or rockshaft arms 1250 are pivotally mounted to a belt tensioning arm pivot 1255. The plurality of movable rolls comprise a first movable roll 1260, a second movable roll 1265, a third movable roll 1270, and a fourth movable roll 1275, which extend between and have opposite ends, respectively, rotatably coupled to the transversely-spaced belt tensioning arms 1250. As illustrated, one or more of the fixed rolls are driven to cause the plurality of baler belts 1190 to be driven, with the drive direction being such as to cause the incoming cotton, or other crop, to travel counterclockwise as it is added as a spiral layer to a growing round module 1100. As the round module 1100 grows within the module-forming chamber 1185, the transversely spaced belt tensioning arms 1250 rotate counterclockwise until a round module 1100 having a predetermined diameter has been formed in the module-forming chamber 1185.

Along the rear portion of the round module builder 1080 may be a wrapping assembly 1090 that houses one or more wrap roll 280. In the embodiment illustrated in FIG. 5, only one wrap roll 1280 is shown positioned in the wrapping assembly 1090. However, the wrapping assembly 1090 is configured to stack multiple wrap rolls 1280 on top of one another within a wrap roll hopper 1282. The bottom most wrap roll 1280 may rest on a front carry roller 1284 and a rear carry roller 1286. The front and rear carry rollers 1284, 1286 may be coupled to a bracket (not particularly shown) that allows the front and rear carry rollers 1284, 1286 to move along a linear path towards, and away from, a lower wrap roller 1288.

The wrap roll 1280 may be a wrap material sized to cover the exterior circumference of a round module 1100. The wrap material may transition from the wrap roll 1280, partially around the front carry roller 1284, between the front carry roller 1284 and the lower wrap roller 1288, partially around the lower wrap roller 1188 and to the lower front gate roll 1245. Once the wrap material enters the module forming chamber 1185 at the lower front gate roll 1245, the wrap material may follow the baler belts 1190 about the circumference of the round module 1100 until the outer periphery is substantially covered with wrap material. For hay and forage balers, a cutting assembly (not specifically shown) may then cut the wrap material from the wrap roll and the wrap material may adhere to the round module to substantially maintain its form once ejected from the module forming chamber. In the illustrated embodiment, the wrap material is sized for individual portions from the wrap roll 1280 that do not require cutting device but are sized to adhere to the round module 1100 to maintain its form once ejected from the module forming chamber 1185.

In one aspect of the wrapping assembly 1090 illustrated in FIG. 5, the wrap material is stretched as it extends between the lower wrap roller 1288 and the lower front gate roll 1245. More specifically, one or more of the front and rear carry rollers 1284, 1286 and the lower wrap roller 1288 may be powered to feed wrap material from the wrap roll 1280 to the module forming chamber 1185. In various implementations, the wrap material may be pinched between the frontcarry rollers 1284 and the lower wrap roller 1288 as it is fed from the wrap roll 1280 to the module forming chamber 1185. In other implementations, the wrap material may be pinched between both the front and rear carry roller 1284, 1286 and the lower wrap roller 1288.

The powered roller 1284, 1286, 1288 may send the wrap material toward the lower front gate roll 1245 at a linear feed speed. The feed speed may be slightly less than the speed required to match the linear surface speed of the round module 1100. In an example implementation, the round module may have a twenty-three foot circumference and thereby require approximately twenty-three linear feet of wrap material per rotation. The wrapping assembly 1090 may have a feed speed of approximately 19-23 linear feet per rotation. In this embodiment, as the wrap material transitions from the wrap roll 1280 to the module forming chamber 1185, the wrap material is stretched as it moves between the lower wrap roller 1288 and the lower front gate roll 1245.

Stretching the wrap material as it transitions from the wrapping assembly 1090 to the module forming chamber 1185 may provide for a tightly packed round module 1100 that has a high density and therefor transports a large amount of harvested crop. Further, the wrap material may compress the round module 1100 so that it maintains the proper form. Properly covering the outer surface of the round module 1100 may also inhibit moister from penetrating the outer surface of the round module 1100. Referring back to FIG. 4, after the round module 1100 is formed and wrapped, a module handling system 1330 may receive the round module 1100. The module handling system 1330 temporarily supports the round module 1100 and then discharges it from the harvester 1010.

In operation, the harvester 1010 is driven through the field 1035 to harvest cotton or other crop. The illustrated harvesting structure 1055 picks cotton from cotton plants in the field 1035. Alternatively, the harvesting structure 1055 may strip the cotton from the cotton plants. Cotton is transferred to the accumulator 1065 via the air duct system 1060. The accumulator 1065 holds the cotton until a predetermined cotton level is reached and then transfers the cotton to the feeder 1070. In an exemplary embodiment, the accumulator 1065 transfers cotton to the feeder 1070 approximately four times for each round module 1100 produced. When the feeder 1070 receives cotton, the plurality of rollers 1075 are activated to distribute the cotton to a feed conveyor belt that transfers the cotton to the round module builder 1080. The round module builder 1080 uses the baler belts 1090 to compress the cotton while forming the module 1100.

After the round module builder 1080 receives compressed cotton, the plurality of baler belts 1190 rotate the cotton into the round module 1100. After the round module builder 1080 receives sufficient cotton from the feeder 1070, the round module may be wrapped and the round module 1100 can be ejected onto the module handling system 1330. The module handling system 1330 supports the round module 1100 and then discharges it from the harvester 1010. The harvester 1010 is adapted for movement through a field 1035 to harvest cotton.

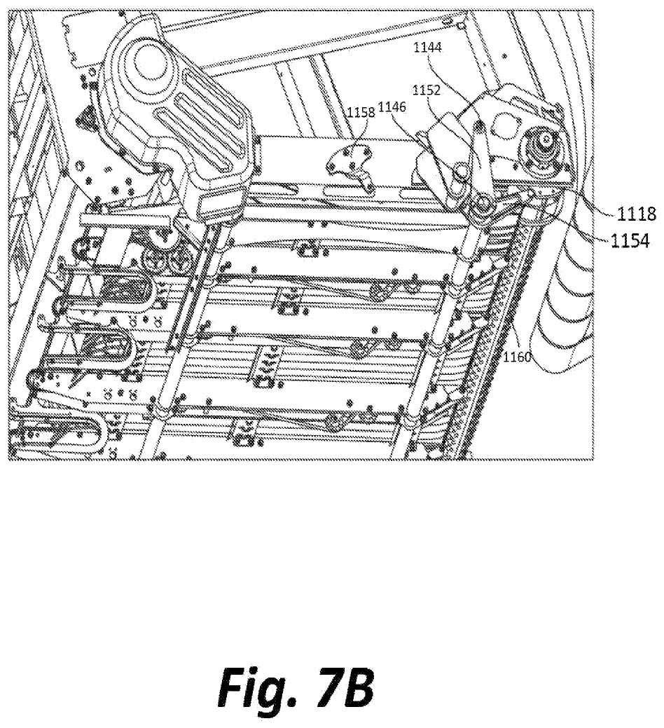

Referring now to FIGS. 6, 7A, and 7B, a different embodiment of a wrapping assembly 1302 is illustrated. More specifically, the wrapping assembly 1302 may have a wrap roll hopper 1304 similar to the wrap roll hopper 1282 described above. The wrap roll hopper 1304 may provide for storage for a plurality of wrap rolls wherein the bottom-most wrap roll contacts an upper front wrap roller 1306 and a carry roller 1308. Both the upper front wrap roller 1306 and the carry roller 308 may be rotationally coupled to the first and second walls of 1032 or 1028 of the round module builder 1080. The upper front wrap roller 1306 may be rotationally coupled to the first and second side walls of 1032 or 1028 about a first axis 1310 and the carry roller 1308 may be rotationally coupled to the first and second side walls of 1032 or 1028 about a carry axis 1312. In various implementations, the first axis 1310 and the carry axis 1312 may not move relative to the first and second side walls of 1032 or 1028 or otherwise relative to the round module builder 1080.

The wrapping assembly 1302 may also have a lower wrap roller 1314 that is positionable adjacent to the upper front wrap roller 1306. The lower wrap roller 1314 may be rotationally coupled between a first bracket 1316 and second bracket (not shown). The first bracket 1316 may be pivotally coupled to the first wall of 1032 or 1028 about a bracket axis 1320 and the second bracket may be pivotally coupled to the second wall of 1032 about the bracket axis 1320.

The lower wrap roller 1314 may be pivotal about the bracket axis 1320 between a first position (as shown in FIG. 6), and a second position. In the first position, the outer surface of the lower wrap roller 1314 may be positioned adjacent to the outer surface of the upper front wrap roller 1306. More specifically, in the first position the wrap material may be pinched between the upper front wrap roller 1306 and the lower wrap roller 1314 at a pinch point 1406 (see FIG. -7). Pinching the wrap material between the upper front wrap roller 1306 and the lower wrap roller 1314 allows the rotation speed of the rollers 1306, 1314 to partially control the feed speed as is described in more detail below.

In one aspect of the embodiment of FIG. 6, the outer surface of the upper front wrap roller 1306 and the outer surface of the lower wrap roller 1314 may be coated in a material that grips the wrap material such as rubber or the like. The outer surface of the rollers 1306, 1314 may then control the feed speed of the wrap material to the lower front gate roll 1245 without allowing the wrap material to slip there between. In other words, the outer surface of the rollers 1306, 1314 may frictionally engage the wrap material as it is pinched between the respective rollers 1306, 1314 at the pinch point 1406 and as it travels from the wrap roll to the module forming chamber 1185. In this configuration, the stretch force generated on the wrap material between the lower front gate roll 1245 and the lower wrap roller 1314 may be insufficient to cause the wrap material to slip between the upper front wrap roller 1306 and the lower wrap roller 1314.

In one embodiment, a biasing member (not illustrated) such as a spring or the like may be positioned between the first bracket 1316 and the second bracket and the corresponding first and second walls of 1032 or 1028 to pivot the lower wrap roller 1314 about the bracket axis 1320 towards the upper front wrap roller 1306. The force applied to the first bracket 1316 and the second bracket by the biasing member may increase the pinch force on the wrap material and thereby reduce the likeliness of the wrap material slipping there between during heavy stretch forces.

The biasing member may be any type of spring or the like known in the art and is not limited to any particular type. More specifically, the biasing member may be generated by any type of mechanical, pneumatic, hydraulic, electrical or the like force. In one non-limiting example, the biasing member 1402 is a coil spring. In another example, the biasing member is a hydraulic, pneumatic, or electrical actuator. A person having skill in the relevant art understands the many different types of biasing members 1402 that can be utilized to bias a pivoting member about an axis and this disclosure is not limited to any particular one.

Although the present disclosure herein has been described with reference to particular embodiments, it is to be understood that these embodiments are merely illustrative of the principles and applications of the present disclosure. Examples herein that specified cotton, or materials such as paper or plastic, may be replaced with other objects and materials as noted herein. It is therefore to be understood that numerous modifications may be made to the illustrative embodiments and that other arrangements may be devised without departing from the spirit and scope of the present disclosure as defined by the appended claims.

1. A wrapping material for wrapping around a baled agricultural product, the wrapping material comprising a wrapping unit extending from a leading end to a trailing end, the wrapping unit including a reduced risk material portion extending a distance along the wrapping unit from the leading end.

2. The wrapping material of claim 1, wherein the reduced risk material portion has a length that extends around at least a portion of a perimeter of the baled agricultural product when the wrapping material is wrapped around the baled agricultural product.

3. The wrapping material of claim 1, wherein the wrapping unit further includes a polymeric portion extending a distance along the wrapping unit from the trailing end.

4. The wrapping material of claim 3, wherein the polymeric portion has a length that extends around at least a portion of the perimeter of the baled agricultural product, wherein the wrapping unit completes at least one revolution around the baled agricultural product.

5. The wrapping material of claim 4, wherein the length of the reduced risk material portion is about 20% or less of a total length of the wrapping unit.

6. The wrapping material of claim 4, wherein the wrapping unit has a length that extends at least two revolutions around the baled agricultural product.

7. The wrapping material of claim 4, wherein the reduced risk material portion has a length sufficient to extend at least one complete revolution around the baled agricultural product, and the polymeric portion has a length sufficient to extend around at least a portion of the perimeter of the baled agricultural product.

8. The wrapping material of claim 7, wherein the reduced risk material portion is adjacent to the baled agricultural product and the polymeric portion is positioned over at least part of the reduced risk material portion.

9. The wrapping material of claim 1, wherein the reduced risk material portion has a length that extends at least one complete revolution around the perimeter of the baled agricultural product when the wrapping material is wrapped around the baled agricultural product.

10. The wrapping material of claim 9, wherein the polymeric portion has a length that extends around the baled agricultural product at least in a second layer to surround at least part of the reduced risk material portion when the wrapping material is wrapped around the baled agricultural product.

11. The wrapping material of claim 1, wherein the reduced risk material portion has a length that extends more than one complete revolution around the perimeter of the baled agricultural product such that a second layer of the reduced risk material portion surrounds at least part of a first layer of the reduced risk material portion when the wrapping material is wrapped around the baled agricultural product.

12. The wrapping material of claim 1, wherein the reduced risk material portion extends from the leading end to the trailing end of the wrapping unit.

13. The wrapping material of claim 1, wherein the reduced risk material portion includes a water-resistant additive, treatment or coating.

14. The wrapping material of claim 1, wherein a plurality of wrapping units are releasably attached in a sequence, such that the trailing end of each wrapping unit is releasably attached to the reduced risk material portion of a trailing wrapping unit.

15. The wrapping material of claim 1, wherein the reduced risk material portion of the wrapping unit is a predetermined length and width.

16. The wrapping material of claim 1, wherein the reduced risk material portion is formed of paper, crepe paper, cellulose-based materials, starch-based materials, linen, cotton-based materials, or any combination thereof.

17. The wrapping material of claim 3, wherein the polymeric portion extends between the reduced risk material portion and the trailing end.

18. The wrapping material of claim 1, wherein the reduced risk material portion of the wrapping unit extends from the leading end to the trailing end, and the wrapping unit is configured to be cut into individual wrapping unit portions for each portion sized to be wrapped around the baled agricultural product.

19. The wrapping material of claim 1, wherein the wrapping unit further includes a polymer portion extending a distance along the wrapping unit from the trailing end, the reduced risk material portion sized to be included, once positioned around the baled agricultural product, in a first portion of a first layer of the wrapping unit, and the polymer portion sized to be included in a second portion of the first layer of the wrapping unit, a second layer of the wrapping unit, and a third layer of the wrapping unit.

20. The wrapping material of claim 19, wherein the polymer portion in the second portion of the first layer is adhered to the second layer and the second layer is adhered to the third layer.

21. The wrapping material of claim 20, wherein upon removal of the wrapping material from the baled agricultural product, the polymer portion remains a single piece.

22. The wrapping material of claim 19, wherein at least a part of the polymer portion in the second portion of the first layer includes a tacky surface facing away from the baled agricultural product.

23. The wrapping material of claim 19, wherein at least part of the polymer portion constituting the second layer of the wrapping unit, once positioned around the baled agricultural product, includes a tacky surface facing away from the baled agricultural product, facing towards the baled agricultural product, or both facing away and facing towards the baled agricultural product.

24. The wrapping material of claim 19, wherein at least part of the polymer portion constituting the third layer of the wrapping unit, once positioned around the baled agricultural product, includes a tacky surface facing towards the baled agricultural product.

25. The wrapping material of claim 19, wherein at least part of the reduced risk material portion, once positioned around the baled agricultural product, includes a surface texture on at least a portion of at least one surface.

26. A method of manufacturing a wrapping unit, comprising:
forming a reduced risk material portion having a length and a width;
forming a polymeric portion having a length and a width; and
securing the polymeric portion to the reduced risk material portion.

27. The method of claim 26, wherein forming a wrapping unit further comprises forming a plurality of wrapping units extending in a sequence, a trailing end of each leading wrapping unit releasably attached to a leading end of a trailing wrapping unit.

28. The method of claim 27, wherein the releasable attachment between the trailing end of each leading wrapping unit to the reduced risk material portion of a trailing wrapping unit includes a Z-Lock system, the Z-Lock system including a V-fold on one of the wrapping units.

29. The method of claim 26, wherein the securing step includes securing a leading end of the polymeric portion to a trailing end of the reduced risk material portion.

30. The method of claim 26, wherein the securing step includes securing the polymeric portion to the reduced risk material portion along the widths of both the polymeric and reduced risk material portions.
